(19) United States
(12) Patent Application Publication
(10) Pub. No.: US 2026/0195075 A1
(43) Pub. Date: Jul. 9, 2026

(54) MEMORY SYSTEM

(71) Applicant: Kioxia Corporation, Tokyo (JP)

(72) Inventor: Kazuhiro FUKUTOMI, Yokohama (JP)

(73) Assignee: Kioxia Corporation, Tokyo (JP)

(21) Appl. No.: 19/298,746

(22) Filed: Aug. 13, 2025

(30) Foreign Application Priority Data
Jan. 6, 2025 (JP) 2025-000045

(51) Int. Cl. G06F 3/06

(52) U.S. Cl. CPC G06F 3/0679; G06F 2212/1041

(57) ABSTRACT

A memory system includes a nonvolatile memory including full blocks, each divisible into subblocks and having a capacity; and a controller configured to: set each full block to either a first or second mode; in response to receiving a write request of first data associated with a first management unit, write the first data into a third subblock allocated to the first management unit; and when a total data amount of valid data stored in fourth subblocks allocated to the first management unit reaches the capacity, transcribe valid data of an amount of the capacity from the fourth subblocks to one first full block.

### CROSS-REFERENCE TO RELATED APPLICATION

This application is based upon and claims the benefit of priority from Japanese Patent Application No. 2025-000045, filed Jan. 6, 2025, the entire contents of which are incorporated herein by reference.

### FIELD

Embodiments described herein relate generally to a technique of controlling a nonvolatile memory.

### BACKGROUND

In recent years, memory systems including nonvolatile memories have become widespread. As such a memory system, a solid state drive (SSD) including a NAND flash memory is known. The SSD is used as a main storage in a variety of computing devices.

The memory system may have a multi-stream function. The multi-stream function is a function of receiving a write request associated with one of a plurality of streams from a host, and writing data associated with the write request to a block in a nonvolatile memory allocated to the one stream. In other words, the memory system having the multi-stream function switches a write destination block for each stream. The plurality of streams are used, for example, to write plurality of pieces of data having different lifetimes to different blocks.

Similarly, in a memory system having the Flexible Data Placement (FDP) or Zoned Namespace (ZNS) function of the NVM Express™ (NVMe™) standard, the write destination block can be switched for each certain management unit.

A block allocated as a write destination is, for example, a superblock. The superblock is a set of a plurality of physical blocks that can be accessed in parallel.

### DESCRIPTION OF THE DRAWINGS

FIG. 1 is a block diagram showing a configuration example of an information processing system including a memory system according to an embodiment;

FIG. 2 is a diagram showing a configuration example of a memory chip in the memory system according to the embodiment;

FIG. 3 is a diagram showing a circuit configuration example of a physical block in the memory system according to the embodiment;

FIG. 4A is a diagram showing an example of a physical full block used in the memory system according to the embodiment, and FIG. 4B is a diagram showing an example of a physical subblock used in the memory system according to the embodiment;

FIG. 5 is a diagram showing a configuration example of a superblock used in the memory system according to the embodiment;

FIG. 6 is a diagram showing a configuration example of a super subblock used in the memory system according to the embodiment;

FIG. 7 is a diagram showing a configuration example of address conversion management information used in the memory system according to the embodiment;

FIG. 8 is a diagram showing a configuration example of valid data amount management information used in the memory system according to the embodiment;

FIG. 9 is a diagram showing a configuration example of wear management information used in the memory system according to the embodiment;

FIG. 10 is a diagram showing a configuration example of an active full block list used in the memory system according to the embodiment;

FIG. 11 is a diagram showing a configuration example of an active subblock list used in the memory system according to the embodiment;

FIG. 12 is a diagram showing a configuration example of a free full block list used in the memory system according to the embodiment;

FIG. 13 is a diagram showing a configuration example of a free subblock list used in the memory system according to the embodiment;

FIG. 14 is a diagram showing an example of a host write operation and a sub-full block transcription operation in the memory system according to the embodiment;

FIG. 15 is a diagram showing an example of a refresh operation in the memory system according to the embodiment;

FIGS. 16A and 16B are diagrams showing examples of a first free block allocation operation when a mode of each block is fixed in the memory system according to the embodiment;

FIG. 17 is a diagram showing an example of a second free block allocation operation when the mode of each block is not fixed in the memory system according to the embodiment;

FIG. 18 is a diagram showing an example of a block to be subjected to a wear leveling operation in the memory system according to the embodiment;

FIG. 19 is a flowchart showing an example of a procedure of a write command process executed in the memory system according to the embodiment;

FIG. 20 is a flowchart showing an example of a procedure of a first transcription process executed in the memory system according to the embodiment;

FIG. 21 is a flowchart showing an example of a procedure of a read command process executed in the memory system according to the embodiment;

FIG. 22 is a flowchart showing an example of a procedure of a free subblock allocation process executed in the memory system according to the embodiment;

FIG. 23 is a flowchart showing an example of a procedure of a refresh process executed in the memory system according to the embodiment;

FIG. 24 is a flowchart showing an example of a procedure of a free full block allocation process executed in the memory system according to the embodiment;

FIG. 25 is a flowchart showing an example of a procedure of a subblock wear leveling process executed in the memory system according to the embodiment;

FIG. 26 is a flowchart showing an example of a procedure of a full block wear leveling process executed in the memory system according to the embodiment;

FIG. 27 is a flowchart showing an example of a procedure of a second transcription process executed in the memory system according to the embodiment;

FIG. 28 is a flowchart showing an example of a procedure of a block list update process executed in the memory system according to the embodiment; and

FIG. 29 is a flowchart showing an example of a procedure of a third transcription process executed in the memory system according to the embodiment.

### DETAILED DESCRIPTION

When a size of a block (for example, a superblock or a physical block) becomes larger, a total storage capacity of blocks allocated as write destinations to a plurality of management units also increases. Accordingly, available capacity of the memory system decreases.

Embodiments provide a memory system that can efficiently use a nonvolatile memory.

In general, according to one embodiment, a memory system is connectable to a host. The memory system includes a nonvolatile memory and a controller electrically connected to the nonvolatile memory. The nonvolatile memory includes a plurality of full blocks, each of which is divisible into two or more subblocks and has a first capacity. The controller is configured to: set each of the plurality of full blocks to either a first mode or a second mode such that the plurality of full blocks include a plurality of first full blocks set to the first mode and a plurality of second full blocks set to the second mode, the full block set to the first mode being used as a full block, the full block set to the second mode being used as two or more subblocks, the two or more subblocks included in the full block set to the second mode including a plurality of first subblocks; manage a plurality of management units, the plurality of management units including at least a first management unit; allocate a plurality of second subblocks among the plurality of first subblocks to the first management unit; in response to receiving, from the host, a write request of first data associated with the first management unit, write the first data into a third subblock among the plurality of second subblocks allocated to the first management unit; and when a total data amount of valid data stored in a plurality of fourth subblocks among the plurality of second subblocks reaches the first capacity, transcribe valid data of an amount of the first capacity from the plurality of fourth subblocks to one of the plurality of first full blocks.

Hereinafter, an embodiment will be described with reference to the drawings.

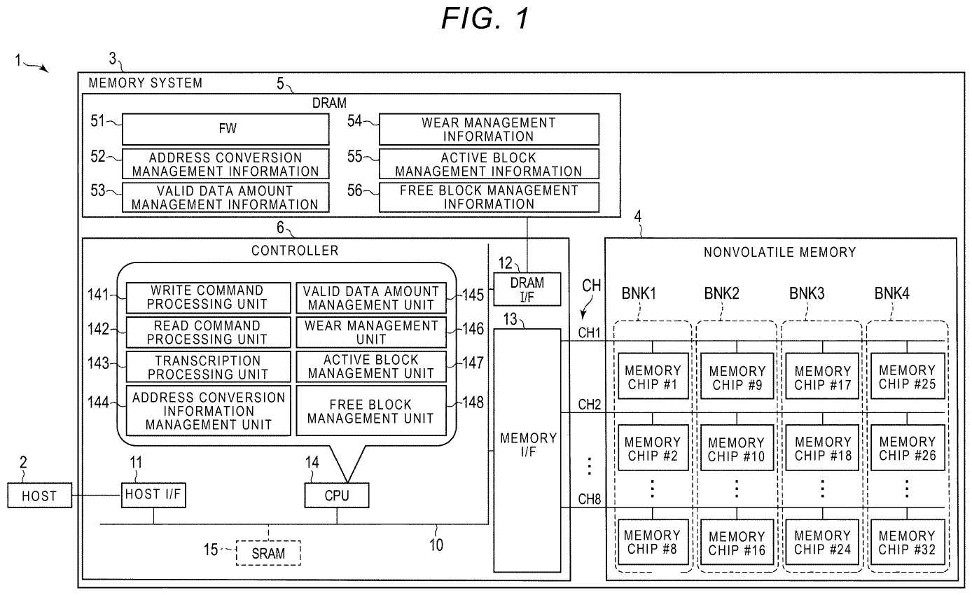

First, with reference to FIG. 1, a configuration example of an information processing system including a memory system according to the embodiment will be described. An information processing system 1 includes, for example, a host device 2 and a memory system 3.

The host device 2 may be a storage server that stores a large amount of various types of data in the memory system 3, or may be a personal computer. Hereinafter, the host device 2 will also be referred to as a host 2.

The memory system 3 is a storage device configured to write data to a nonvolatile memory 4 and read data from the nonvolatile memory 4. The memory system 3 is also referred to as a storage device. The nonvolatile memory 4 is, for example, a NAND flash memory. The memory system 3 is implemented, for example, as an SSD including a NAND flash memory.

The memory system 3 can be used as a storage of the host 2. The memory system 3 may be built into the host 2, or may be connected to the host 2 via a cable or a network.

An interface for connecting the host 2 to the memory system 3 complies with a standard such as PCI Express™ (PCIe™), Ethernet™, Fibre channel, or NVM Express™ (NVMe™).

The memory system 3 includes, for example, the nonvolatile memory 4, a dynamic random access memory (DRAM) 5, and a controller 6.

The nonvolatile memory 4 includes, for example, a plurality of memory chips. Each of the plurality of memory chips is capable of operating independently. In other words, each of the plurality of memory chips functions as a unit capable of operating in parallel. The plurality of memory chips are, for example, 32 memory chips #1 to #32. Each of the plurality of memory chips is connected to the controller 6 via, for example, any one of a plurality of channels CH. The plurality of channels CH are, for example, eight channels CH1 to CH8. The plurality of memory chips, for example, configure a plurality of banks. The bank is a unit in which at least two of the plurality of memory chips are operated in parallel by an interleaving operation. The plurality of banks are, for example, four banks BNK1, BNK2, BNK3, and BNK4. Each of the four banks BNK1, BNK2, BNK3, and BNK4 is configured with, for example, eight memory chips.

In the example shown in FIG. 1, the memory chips #1, #9, #17, and #25 are connected to the controller 6 via the channel CH1. The memory chips #2, #10, #18, and #26 are connected to the controller 6 via the channel CH2. The memory chips #8, #16, #24, and #32 are connected to the controller 6 via the channel CH8. The memory chips #1 to #8 configure the bank BNK1. The memory chips #9 to #16 configure the bank BNK2. The memory chips #17 to #24 configure the bank BNK3. The memory chips #25 to #32 configure the bank BNK4.

Hereinafter, any one of the plurality of memory chips may be referred to as a memory chip.

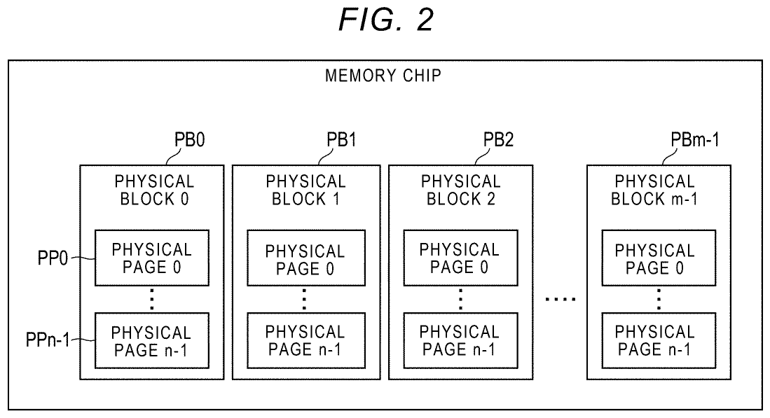

FIG. 2 shows a configuration example of the memory chip. The memory chip includes a plurality of physical blocks PB0, PB1, PB2, . . . , and PBm−1. Each of the plurality of physical blocks PB0, PB1, PB2, . . . , and PBm−1 functions as a unit of a data erase operation. A physical block is also referred to as an erase block. Each of the plurality of physical blocks PB0, PB1, PB2, . . . , and PBm−1 includes a plurality of physical pages PP0, . . . , and PPn−1. Each of the plurality of physical pages PP0, . . . , and PPn−1 includes a plurality of memory cells connected to a single word line (WL). Each of the plurality of physical pages PP0, . . . , and PPn−1 functions as a unit of a data write operation and a data read operation. Note that the word line may function as the unit of the data write operation and the data read operation.

An upper limit exists for the number of program/erase cycles (number of P/E cycles) that each of the plurality of physical blocks PB0, PB1, PB2, . . . , and PBm−1 can tolerate, and the upper limit is referred to as the maximum number of P/E cycles. One P/E cycle of a certain physical block includes a data erase operation of setting all memory cells in the physical block to an erased state, and a program operation of writing data to each physical page of the physical block.

In the memory system 3, each of a plurality of physical subblocks obtained by dividing a physical block may be configured so that each of the subblocks functions as a unit of the data erase operation. For example, when the size of a physical block is large, a physical subblock preferably functions as a unit of the data erase operation. A physical block configured with a plurality of physical subblocks is also referred to as a physical full block.

### (Circuit Example of Physical Block)

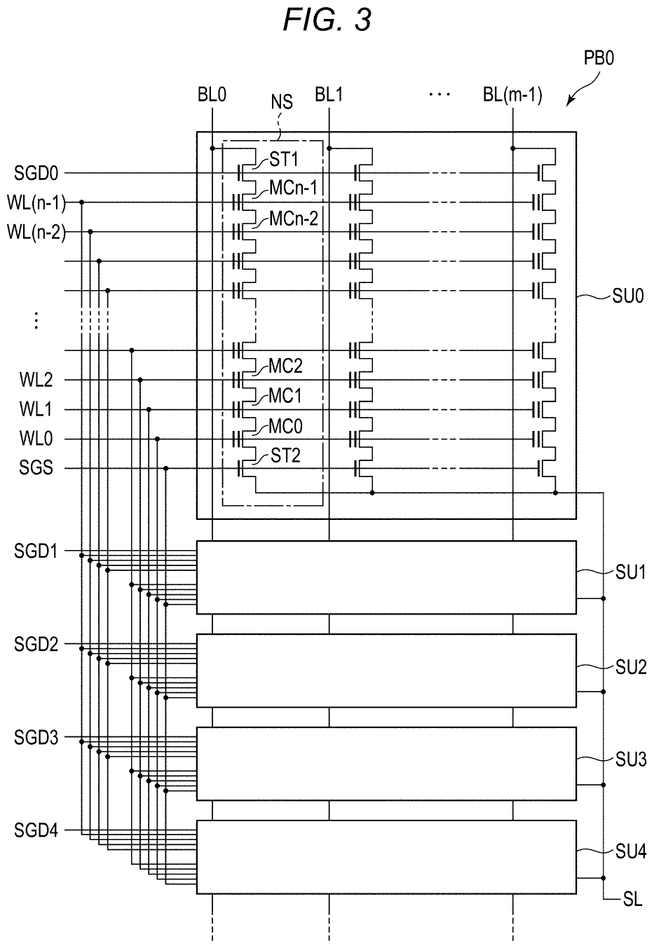

A circuit configuration of the physical block will be described with reference to FIG. 3. FIG. 3 shows a circuit configuration of the physical block PB0 in each memory chip. The rest of physical blocks PB in each memory chip have the same configuration as that shown in FIG. 3.

The physical block PB0 includes, for example, five string units SU0, SU1, SU2, SU3, and SU4. Each string unit SU is, for example, a set of a plurality of NAND strings NS collectively selected in a write operation or a read operation. Each string unit SU includes a plurality of NAND strings NS each associated with each of bit lines BL0, BL1, . . . , BL(m−1). Here, m is an integer of 1 or larger. The NAND string NS is a set of a plurality of memory cells MC (MC0, . . . , MC(n−1)) connected in series. Each NAND string NS includes, for example, memory cells MC0, MC1, MC2, MC3, . . . , MC(n−2), MC(n−1), a select transistor ST1, and a select transistor ST2. Here, n is an integer of 1 or larger. A memory cell (also referred to as a memory cell transistor) MC may be a field effect transistor including a control gate and a charge storage layer. The select transistors ST1 and ST2 are switching elements. Each of the select transistors ST1 and ST2 is used to select a string unit SU in various operations.

The memory cells MC0, . . . , MC(n−1) are connected in series in each NAND string NS. The drain of the select transistor ST1 is connected to an associated bit line BL. The source of the select transistor ST1 is connected to one end of the memory cells MC0, . . . , MC(n−1) connected in series. The drain of the select transistor ST2 is connected to the other end of the memory cells MC0, . . . , MC(n−1) connected in series. The source of the select transistor ST2 is connected to a source line SL.

In the same physical block PB, the control gates of the memory cells MC0, MC1, MC2, MC3, . . . , MC(n−2), MC(n−1) are commonly connected to word lines WL0, WL1, WL2, WL3, . . . , WL(n−2), WL(n−1) among a plurality of NAND strings. The gates of the select transistors ST1 in the string units SU0, SU1, SU2, SU3, and SU4 are commonly connected to each of select gate lines SGD0, SGD1, SGD2, SGD3, and SGD4 among a plurality of NAND strings. The gates of the select transistors ST2 in the same physical block PB are commonly connected to a select gate line SGS among a plurality of NAND strings.

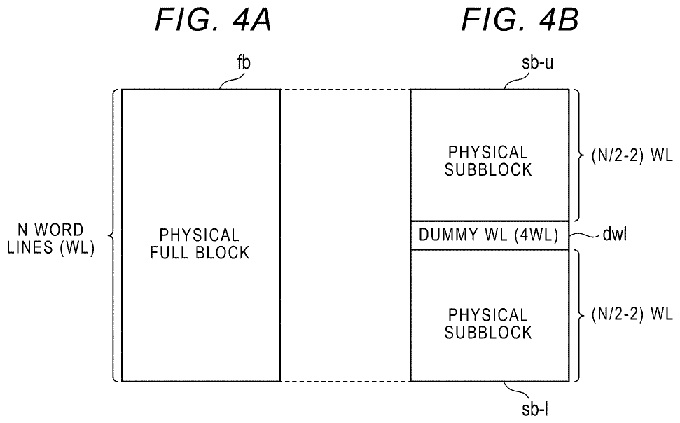

FIG. 4A shows an example of a physical full block, and FIG. 4B shows an example of a physical subblock.

A physical full block fb shown in FIG. 4A includes, for example, N word lines. N is, for example, 96. A plurality of memory cells are connected to each of the N word lines. The physical full block fb is divisible into two or more physical subblocks.

A physical subblock sb-u and a physical subblock sb-l shown in FIG. 4B are a plurality of (here, two) physical subblocks obtained by dividing the physical full block fb. Specifically, the physical full block fb includes, for example, the physical subblocks sb-u (e.g., including N/2−2 word lines) and sb-l (e.g., including N/2−2 word lines), and one or more dummy word lines dwl (e.g., 4 dummy word lines) located between the physical subblock sb-u and the physical subblock sb-l. The memory cells connected to the dummy word line dwl are not used for storing valid data. The physical full block fb may be divided into three or more physical subblocks. Hereinafter, a case in which the physical full block fb is divided into the two physical subblocks sb-u and sb-l will be mainly described.

A configuration of physical subblocks is not limited thereto. Physical subblocks sb may be defined in a range of the string unit SU. For example, one physical full block fb includes two physical subblocks sb-0 and sb-1. Here, the physical subblock sb-0 includes a set of string units SU0 to SU2. The physical subblock sb-1 includes a set of string units SU3 to SU5. Alternatively, one physical full block fb may include three physical subblocks sb-0, sb-1, and sb-2. Here, the physical subblock sb-0 includes a set of string units SU0 and SU1. The physical subblock sb-1 includes a set of string units SU2 and SU3. The physical subblock sb-2 includes a set of string units SU4 and SU5.

As yet another example, physical subblocks sb may be defined in a range of the word line WL and the string unit SU. For example, one physical full block fb includes four physical subblocks sb-0, sb-1, sb-2, and sb-3. Here, the physical subblock sb-0 includes a set of word lines WL0 to WL47 of the string units SU0 to SU2. The physical subblock sb-1 includes a set of word lines WL0 to WL47 of the string units SU3 to SU5. The physical subblock sb-2 includes a set of word lines WL48 to WL95 of the string units SU0 to SU2. The physical subblock sb-3 includes a set of word lines WL48 to WL95 of the string units SU3 to SU5.

The controller 6 is configured to set each physical full block to either a full block mode or a subblock mode.

The full block mode is a mode in which a physical full block functions as a unit of the data erase operation. In other words, the full block mode is a mode in which a physical full block is used as one physical full block. A physical full block set to the full block mode is used as a whole.

The subblock mode is a mode in which a physical subblock in a physical full block functions as a unit of the data erase operation. In other words, the subblock mode is a mode in which a physical full block is used as two or more physical subblocks. In a physical full block set to the subblock mode, two or more physical subblocks in the physical full block are used individually.

The controller 6 instructs the memory chip whether to set a certain physical full block to either the full block mode or the subblock mode, for example, using a certain command. The certain command is, for example, a Set Feature command. For example, the controller 6 can switch whether to set a physical full block to either the full block mode or the subblock mode before and after performing a data erase operation.

In the subblock mode, an un-selected block disturb (USBD) may occur. The USBD indicates a case in which, when a data write operation (data program operation) or a data erase operation is performed on one physical subblock (for example, physical subblock sb-u), the other physical subblock (for example, physical subblock sb-l) is affected by the operation. A target physical subblock on which the data write operation or the data erase operation is performed is referred to as a selected physical subblock. Other physical subblocks in the same physical full block as the selected physical subblock are referred to as unselected physical subblocks. Due to the USBD, for example, reliability of data stored in the unselected physical subblocks deteriorates. Specifically, for example, reliability of data stored in the unselected physical subblocks deteriorates due to a voltage applied to the selected physical subblock.

Therefore, when difference between the number of times a data erase operation was performed on a selected physical subblock and the number of times a data erase operation was performed on one of the unselected physical subblocks exceeds a first threshold value, a refresh operation of moving data stored in the unselected physical subblock to another physical full block or physical subblock is required. The first threshold value is, for example, 10% of the maximum number of P/E cycles guaranteed in the memory system 3. More specifically, for example, when the guaranteed maximum number of P/E cycles is 3000, the first threshold value is 300.

In the memory system 3, a superblock may be configured. A superblock is a set of physical full blocks, at least one of which is selected from each of a plurality of memory chips capable of operating in parallel. The superblock is also referred to as a super full block, a logical block, a logical full block, or a block group. A set of physical pages selected one by one from each of a plurality of physical full blocks in a superblock is referred to as a superpage or a logical page.

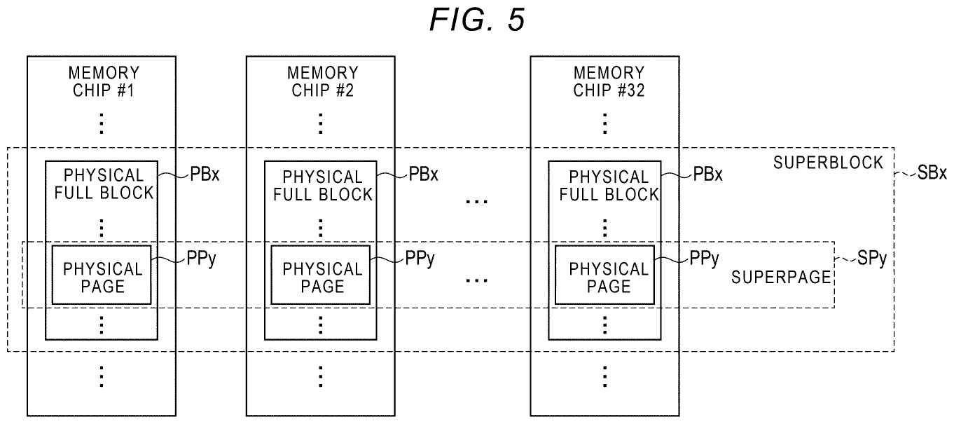

FIG. 5 shows a configuration example of a superblock. Here, a case in which the number of channels is eight, the number of banks is four, and one physical full block is selected from each of a plurality of memory chips capable of operating in parallel is described. Eight channels×four banks configuration corresponds to 32 memory chips #1 to #32. Here, one superblock includes a total of 32 physical full blocks selected one by one from the 32 memory chips #1 to #32.

FIG. 5 illustrates one superblock SBx including 32 physical full blocks PBx. Here, the super block SBx is configured with the x-th physical full block PBx in each of the memory chips #1 to #32. FIG. 5 also illustrates one superpage SPy including physical pages PPy of the 32 physical full blocks PBx. The controller 6 can execute data write operations in parallel on the 32 physical pages PPy in the superpage SPy.

The controller 6 may also be configured to set each superblock to either the full block mode or the subblock mode.

When the superblock SBx is set to the full block mode, the superblock SBx functions as a unit of the data erase operation. The data erase operation on the superblock SBx includes the data erase operation on each of the 32 physical full blocks PBx in the superblock SBx.

When the superblock SBx is set to the subblock mode, a super subblock functions as a unit of the data erase operation. The super subblock includes a total of 32 physical subblocks selected one by one from the 32 physical full blocks PBx in the superblock SBx.

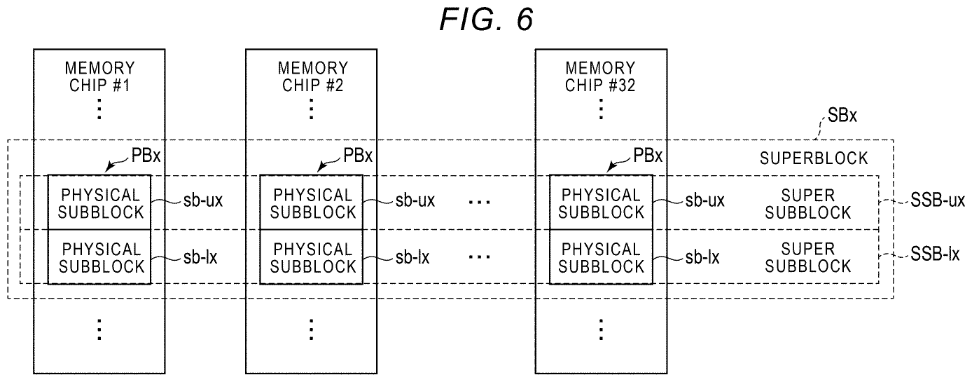

FIG. 6 shows a configuration example of the super subblock. Same as in FIG. 5, a configuration of eight channels×four banks corresponding to 32 memory chips #1 to #32 is illustrated. One physical full block is configured with two physical subblocks. Here, one superblock is configured with two super subblocks. Each of the two super subblocks includes a total of 32 physical subblocks selected one by one from the 32 physical full blocks in the superblock.

FIG. 6 illustrates one superblock SBx including two super subblocks SSB-ux and SSB-lx. The super subblock SSB-ux is configured with a physical subblock sb-ux in the x-th physical full block PBx in each of the memory chips #1 to #32. The super subblock SSB-lx is configured with a physical subblock sb-lx in the x-th physical full block PBx in each of the memory chips #1 to #32.

The controller 6 executes data write operations in parallel on physical pages of a superpage, the physical pages being included in the 32 physical subblocks sb-ux configuring the super subblock SSB-ux (that is, 32 physical pages). The controller 6 executes data write operations in parallel on physical pages of a superpage, the physical pages being included in the 32 physical subblocks sb-lx configuring the super subblock SSB-lx (that is, 32 physical pages).

As described above, when the superblock SBx is set to the subblock mode, each of the super subblocks SSB-ux and SSB-lx functions as a unit of the data erase operation. The data erase operation on the super subblock SSB-ux includes the data erase operation on each of the 32 physical subblocks sb-ux in the super subblock SSB-ux. The data erase operation on the super subblock SSB-lx includes the data erase operation on each of the 32 physical subblocks sb-lx in the super subblock SSB-lx.

A target to be set to either the full block mode or the subblock mode by the controller 6 may be either a superblock or a physical full block. Hereinafter, the term “full block” refers to either a super block or a physical full block. The term “subblock” refers to either a super subblock or a physical subblock. The term “page” refers to either a superpage or a physical page. Note that when a full block refers to a superblock, a subblock refers to a super subblock. When a full block refers to a physical full block, a subblock refers to a physical subblock. A full block and a subblock may be collectively referred to as a block.

The blocks managed in the memory system 3 are roughly divided into active blocks and free blocks.

The active block is a block that is storing valid data and to which new data cannot be written. Valid data is data that may be requested to be read in future by the host 2. Note that data that may not be requested to be read in future by the host 2 is referred to as invalid data. A full block that is an active block is also referred to as an active full block. A subblock that is an active block is also referred to as an active subblock.

The free block is a block not storing valid data and can be used to write new data after undergoing the data erase operation. That is, by undergoing the data erase operation on a free block, the free block can be used, for example, as a new write destination block. The write destination block can store valid data. A free block for which the data erase operation is completed is also referred to as a data-erased block. A full block that is a free block is also referred to as a free full block. A subblock that is a free block is also referred to as a free subblock.

FIG. 1 is referred to again.

The DRAM 5 is a volatile memory. A storage area of the DRAM 5 is allocated, for example, as a storage area for firmware (FW) 51 and cache areas for address conversion management information 52, valid data amount management information 53, wear management information 54, active block management information 55, and free block management information 56. The storage area of the DRAM 5 may be further allocated as a buffer area that temporarily stores user data.

The FW 51 is a program for controlling operations of the controller 6. The FW 51 is loaded, for example, from the nonvolatile memory 4 to the DRAM 5.

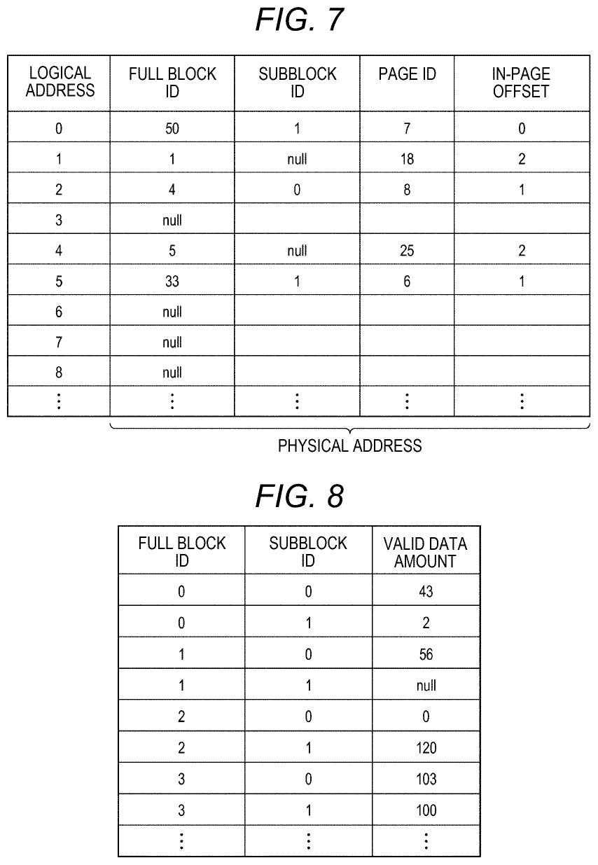

The address conversion management information 52 is information for managing mapping between each logical address and each physical address of the nonvolatile memory 4. The logical address is an address used by the host 2 to designate a storage area in the memory system 3 by address. The logical address is, for example, a logical block address (LBA). The controller 6 can use the address conversion management information 52 and convert a logical address into a physical address. The controller 6 can use the address conversion management information 52 and convert a physical address into a logical address. A certain configuration example of the address conversion management information 52 will be described later with reference to FIG. 7.

The valid data amount management information 53 is information for managing the amount of valid data stored in each block. A certain configuration example of the valid data amount management information 53 will be described later with reference to FIG. 8.

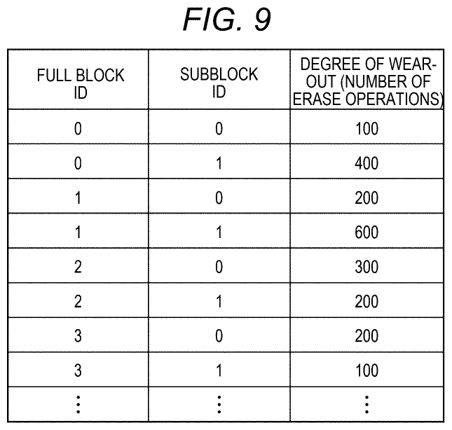

The wear management information 54 is information for managing a degree of wear-out of each block. The degree of wear-out of a block is an index based on, for example, the number of times the data erase operation was performed on the block (hereinafter, also referred to as the number of erase operations). The degree of wear-out of a block may be represented by the number of erase operations performed on the block. A certain configuration example of the wear management information 54 will be described later with reference to FIG. 9.

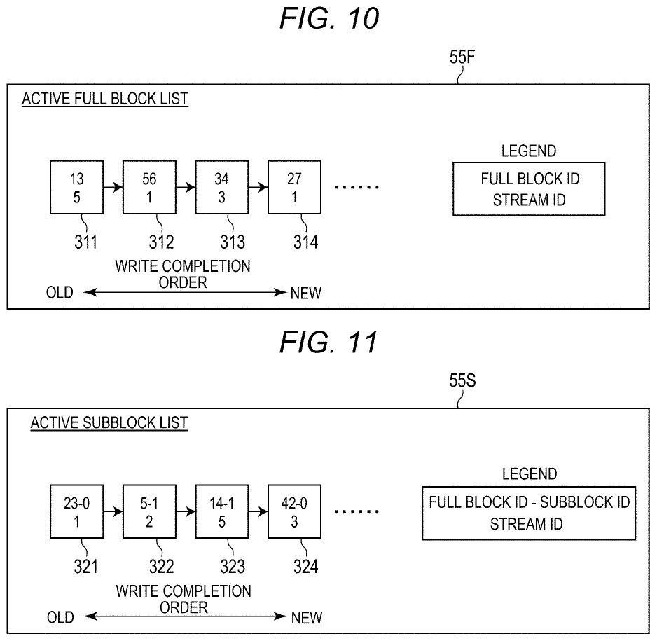

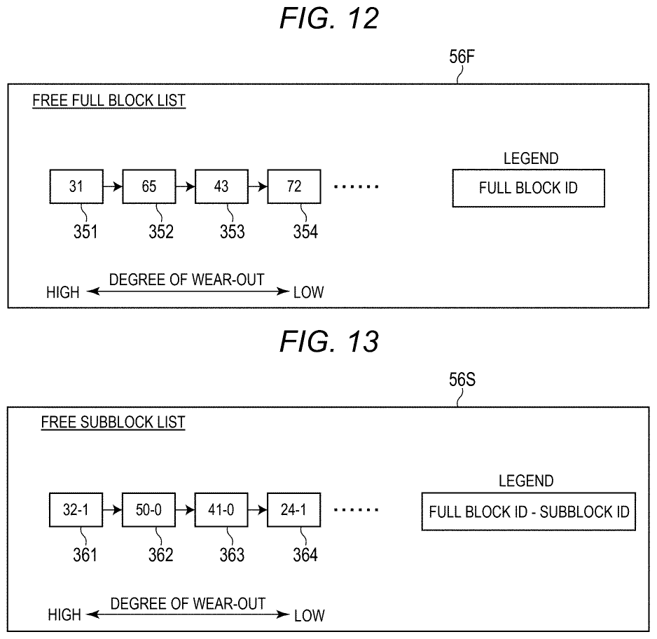

The active block management information 55 is information for managing active blocks. In the active block management information 55, a block in which data is written to its terminal is managed as an active block. A block in which data is written to its terminal is, for example, a block in which the data program operation was performed on all pages in a full block or a subblock. Alternatively, a block in which data is written to its terminal is a block in which the data program operation was performed on at least one memory cell of each of all word lines in the block. Alternatively, a block to which data is written to its terminal may be a block in which data of an amount corresponding to a storage capacity is programmed. A block that becomes a free block by no longer storing any valid data is no longer managed by the active block management information 55. A certain configuration example of the active block management information 55 will be described later with reference to FIGS. 10 and 11.

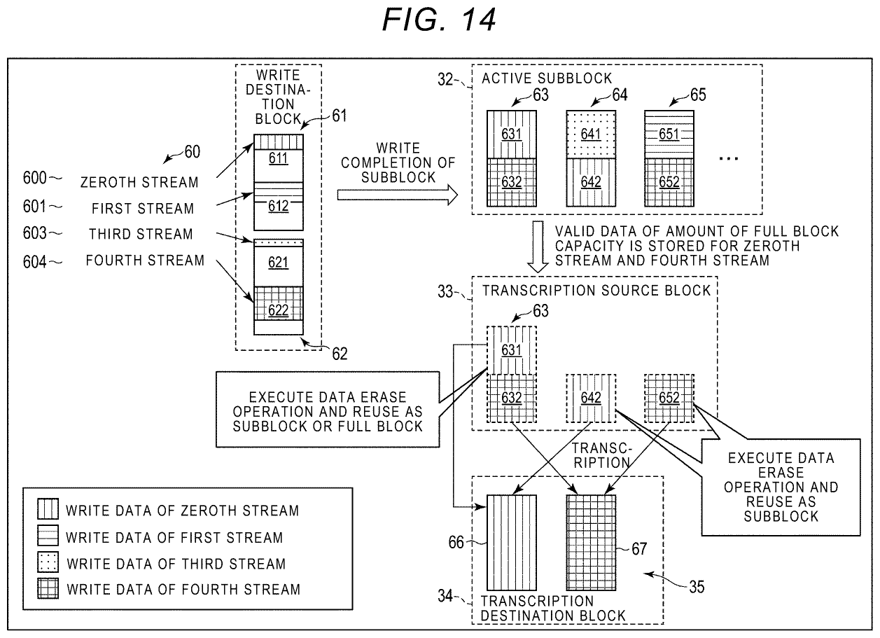

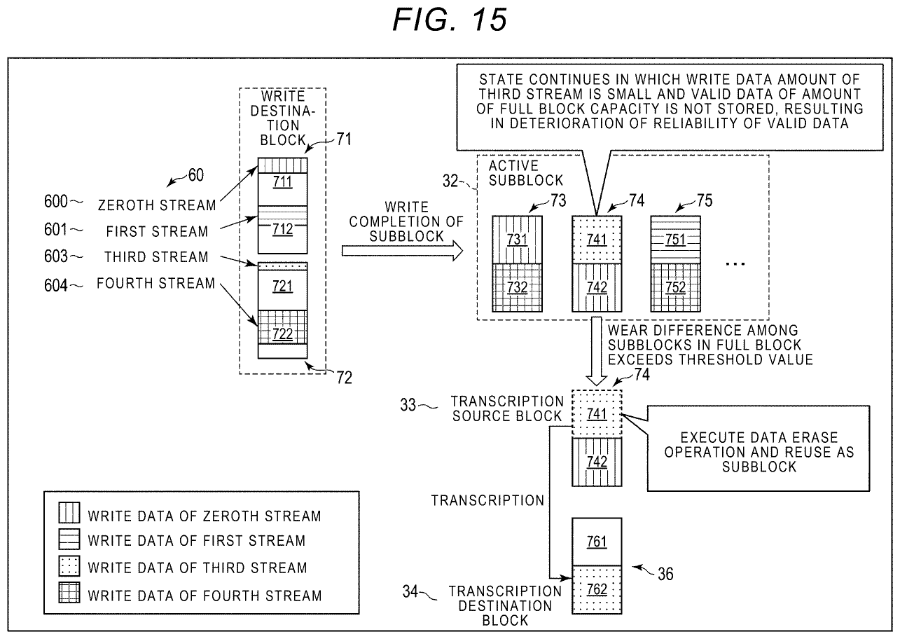

The free block management information 56 is information for managing free blocks. The free block management information 56 may include information for managing data-erased blocks. A certain configuration example of the free block management information 56 will be described later with reference to FIGS. 12 and 13.

The controller 6 may be configured with a circuit such as a system-on-a-chip (SoC). The controller 6 may be configured with a plurality of semiconductor chips. The controller 6 is electrically connected to the nonvolatile memory 4 and configured to control the nonvolatile memory 4. The function of each unit in the controller 6 may be implemented by dedicated hardware in the controller 6, by a processor that executes the FW 51, or by a combination thereof.

The controller 6 may function as a flash translation layer (FTL) configured to perform data management and block management of the nonvolatile memory 4. The data management performed by the FTL includes (1) management of mapping information indicating correspondence between each logical address and each physical address of the nonvolatile memory 4, and (2) process of concealing difference between page-based data read/write operations and block-based data erase operations. The block management includes defective block management, wear leveling, and garbage collection (GC).

The mapping information between each logical address and each physical address is managed using, for example, the address conversion management information 52. The controller 6 uses the address conversion management information 52 and manages the mapping between each logical address and each physical address in certain management size units. A physical address corresponding to a certain logical address indicates a physical storage location in the nonvolatile memory 4 in which data of the logical address is written. The controller 6 uses the address conversion management information 52 and manages a plurality of storage areas obtained by logically dividing the storage area of the nonvolatile memory 4. The size of each of the plurality of storage areas is the above-described management size. Each of the plurality of storage areas corresponds to each of a plurality of logical addresses. In other words, each of the plurality of storage areas is specified by one logical address. The address conversion management information 52 may be loaded from the nonvolatile memory 4 to the DRAM 5 when the memory system 3 is started up.

Data can be written to one memory cell only once in one P/E cycle. Thus, the controller 6 writes updated data corresponding to a certain logical address to a physical storage location different from a physical storage location in which previous data corresponding to the logical address is stored. The controller 6 then updates the address conversion management information 52 and associates the logical address with the different physical storage location, thereby invalidating the previous data. The data referred to by the address conversion management information 52 (that is, data associated with a logical address) is valid data. Data that is not associated with any logical address is invalid data.

The wear leveling is a process for leveling differences in the degree of wear-out between blocks. Specifically, wear leveling is a process of transcribing (copying) valid data in active blocks having a low degree of wear-out to other blocks (for example, data-erased blocks) having a high degree of wear-out. The valid data to be transcribed is considered to be, for example, cold data that is not frequently rewritten. A block from which the valid data is transcribed to another block and that becomes to store only invalid data is released as a free block. When the data erase operation is performed on the free block, and the block is used to store hot data that is frequently rewritten, for example, so that the degree of wear-out (number of erase operations) of the block is expected to increase. Meanwhile, it is expected that the data erase operation is less likely to be performed on said another block to which the valid data (cold data) was transcribed. Therefore, due to wear leveling, difference in degree of wear-out between blocks can be leveled.

The garbage collection is a process for increasing the number of free blocks in the nonvolatile memory 4. Specifically, the garbage collection is a process of transcribing valid data in certain active blocks in which valid data and invalid data are mixed to other blocks (for example, data-erased blocks). The block from which the valid data is transcribed to another block and that becomes to store only invalid data is released as a free block. Thus, the garbage collection can increase the number of free blocks in the nonvolatile memory 4.

The controller 6 includes, for example, a host interface circuit (host I/F) 11, a DRAM interface circuit (DRAM I/F) 12, a memory interface circuit (memory I/F) 13, and a CPU 14. The host I/F 11, the DRAM I/F 12, the memory I/F 13, and the CPU 14 are connected via a bus 10, for example. The controller 6 may further include a static random access memory (SPAN) 15. The SRAM 15 is a volatile memory. The SRAM 15 is connected to each unit in the controller 6 via the bus 10, for example. The SRAM 15 can store at least a part of data (information) stored in the DRAM 5 described above.

The host I/F 11 is a circuit configured to receive various commands (for example, input/output (I/O) commands and control commands) and data from the host 2, and to transmit data and a response to the command to the host 2. The I/O command is, for example, an access command such as a write command or a read command. The write command is a command that requests writing of user data to a designated logical address. The read command is a command that requests reading of user data from a designated logical address. The control commands include, for example, an unmap command (also referred to as a trim command or a deallocate command). The unmap command is a command that requests invalidation of data corresponding to a designated logical address.

The DRAM I/F 12 is a DRAM control circuit configured to control access to the DRAM 5.

The memory I/F 13 is a memory control circuit configured to control the nonvolatile memory 4. The memory I/F 13 may be connected to a plurality of memory chips in the nonvolatile memory 4 via a plurality of channels CH. By driving the plurality of memory chips in parallel, an access bandwidth between the controller 6 and the nonvolatile memory 4 can be widened.

The CPU 14 is a processor configured to control the host I/F 11, the DRAM I/F 12, and the memory I/F 13. The CPU 14 executes the FW 51 loaded from the nonvolatile memory 4 to the DRAM 5 and performs various processes. The FW 51 is a control program that includes a set of instructions for causing the CPU 14 to execute the various processes. The CPU 14 can execute a command process for processing various commands from the host 2. Operation of the CPU 14 is controlled by the FW 51 executed by the CPU 14.

The memory system 3 has, for example, the multi-stream function. The multi-stream function is a function of receiving a write request associated with one of a plurality of streams from outside (here, the host 2) and writing user data associated with the write request to a block in the nonvolatile memory 4 allocated to the one stream. That is, the memory system 3 having the multi-stream function regards a stream as a management unit and switches a write destination block for each stream. The plurality of streams are used, for example, to write user data having different lifetimes to different blocks. Receiving a write request associated with a stream means, more specifically, receiving a write request that designates a stream. The write request is, for example, a write command. The write request may include information (stream ID) that can uniquely identify the designated stream. The stream ID is, for example, a number assigned to the corresponding stream. Hereinafter, it is assumed that a write request is a write command. A block allocated as a write destination is, for example, a subblock.

The memory system 3 may have the FDP function. Here, the host 2 designates a data write destination reclaim unit (RU). The RU is a unit of data management by the memory system 3. For example, one subblock is allocated to one RU.

Alternatively, the memory system 3 may have the ZNS function. Here, an entire logical address space used by the host 2 to access the memory system 3 may be divided into a plurality of subspaces. Each subspace may be referred to as a Namespace. Data stored in the nonvolatile memory 4 is managed for each management unit referred to as a zone, for example. As a method for managing data stored in the nonvolatile memory 4 for each zone, for example, the ZNS defined in the NVMe standard is used. In the ZNS, the entire logical address space of one namespace can be divided into a plurality of zones. Each zone is used as a unit for accessing the nonvolatile memory 4. One zone may correspond to any physical unit in the nonvolatile memory 4. Any physical unit is, for example, one subblock. In the ZNS, information designated by the host 2 in a write command includes a logical address and does not explicitly include a zone identifier. However, the memory system 3 determines a zone in which data is to be stored, based on information on the logical address designated by the host 2. Therefore, similar to the multi-stream function and the FDP function, the host 2 can practically specify a write destination zone.

In recent years, since capacity of nonvolatile memories increases, a size of a physical full block tends to increase. Therefore, a size of a superblock that is a set of physical full blocks is also increasing.

In methods such as the multi-stream, FDP, and ZNS that can switch a data write destination depending on a management unit (for example, stream) designated by a host, for example, a superblock is allocated as a write destination to each of a plurality of management units. Here, when the size of the superblock becomes larger, a total storage capacity of the superblocks allocated as write destinations to the plurality of management units also increases. As a result, overprovisioning capacity of a memory system decreases.

For example, a case in which a memory system having the multi-stream function processes a write command that designates one of 64 streams by multi-threads is considered. Here, when the size of the superblock is 256 MB, the total storage capacity of the 64 superblocks to be allocated as write destinations for the host is 16 GB (=64×256 MB). When the size of the superblock is 1 GB, the total storage capacity of the 64 superblocks to be allocated as write destinations for the host is 64 GB (=64×1 GB). Therefore, when the size of the superblock is 1 GB, overprovisioning capacity of the memory system decreases by 48 GB compared to when the size of the superblock is 256 MB.

In contrast, the memory system 3 according to the embodiment is configured to prevent decrease in overprovisioning capacity and to efficiently use the nonvolatile memory 4. Specifically, the controller 6 of the memory system 3 allocates a plurality of subblocks to a plurality of management units. Here, when each full block includes two subblocks, the total storage capacity of the allocated write destination blocks is decreased by half compared to when a plurality of full blocks are allocated to the plurality of management units. Therefore, in the memory system 3, decrease in overprovisioning capacity can be prevented.

When a total amount of valid data stored in a plurality of subblocks allocated to a certain management unit reaches a storage capacity of a full block (full block capacity), the controller 6 transcribes valid data of an amount of the full block capacity from the plurality of subblocks to a full block. Since information on a block, which is the transcription destination of the valid data, is managed on the full block basis, management of the information on the block (for example, amount of valid data and degree of wear-out) and control based on the information on the block (for example, wear leveling and garbage collection) become easier than management of information on a plurality of blocks, in which the valid data was stored, on the subblock basis. This enables the memory system 3 to easily manage the blocks in the nonvolatile memory 4. Therefore, the memory system 3 can efficiently use the nonvolatile memory 4.

A certain example of an operation of the memory system 3 having the multi-stream function (that is, when the management unit is a stream) will be described below.

The CPU 14 functions, for example, as a write command processing unit 141, a read command processing unit 142, a transcription processing unit 143, an address conversion information management unit 144, a valid data amount management unit 145, a wear management unit 146, an active block management unit 147, and a free block management unit 148. The CPU 14, for example, functions as each of the units by executing the FW 51.

The write command processing unit 141 performs a process according to a write command received from the host 2. Specifically, the write command processing unit 141 writes user data to be written in response to the write command into the nonvolatile memory 4. The writing of the user data in response to the write command received from the host 2 is also referred to as a host write.

A write destination of user data in response to a write command is, for example, a subblock. Here, the write command processing unit 141, for example, allocates each of a plurality of subblocks to each of a plurality of streams as a write destination. When a write command associated with a certain stream is received from the host 2, the write command processing unit 141 writes data corresponding to the write command to a subblock allocated to the certain stream. Here, a total storage capacity of allocated blocks decreases compared to when each of a plurality of full blocks is allocated to each of a plurality of streams. Therefore, substantial decrease in overprovisioning capacity of the nonvolatile memory 4 can be prevented.

The read command processing unit 142 performs a process according to a read command received from the host 2. Specifically, the read command processing unit 142 uses the address conversion management information 52 and acquires a physical address corresponding to a logical address designated by the read command. The read command processing unit 142 reads user data from the nonvolatile memory 4 based on the acquired physical address. Then, the read command processing unit 142 transmits the read user data to the host 2. In the nonvolatile memory 4, the block from which the user data is read is a full block or a subblock.

When valid data of an amount of a full block capacity is stored in a plurality of subblocks allocated to one stream, the transcription processing unit 143 performs a transcription process from the plurality of subblocks to a full block. That is, the transcription processing unit 143 transcribes the valid data of the amount of the full block capacity stored in the plurality of subblocks allocated to one stream to the full block (more specifically, a data-erased full block).

The transcription processing unit 143 performs a process of restoring reliability of data stored in at least one of a plurality of subblocks configuring one full block. Specifically, when a wear difference among subblocks configuring a full block is equal to or greater than the first threshold value, the transcription processing unit 143 transcribes valid data stored in a subblock (more specifically, an active subblock) having a lower degree of wear-out to another block. The wear difference is, for example, difference in degree of wear-out between two subblocks configuring one full block. The transcription processing unit 143 may correct errors in valid data stored in the subblock having the lower degree of wear-out, and transcribe the error-corrected valid data to another block.

The transcription processing unit 143 performs a garbage collection process of obtaining free subblocks and free full blocks. The number of obtained free subblocks is equal to or greater than a second threshold value. The number of obtained free full blocks is equal to or greater than a third threshold value. Specifically, the transcription processing unit 143 transcribes valid data from an active subblock or an active full block having a smaller valid data amount to another block (for example, a data-erased block). Accordingly, a subblock or a full block from which the valid data is transcribed to another block and that stores only invalid data is released as a free block. Therefore, the transcription processing unit 143 can increase the number of free subblocks or the number of free full blocks in the nonvolatile memory 4.

The transcription processing unit 143 performs a wear leveling process on each of the active subblocks and the active full blocks. Specifically, the transcription processing unit 143 transcribes valid data (for example, cold data) in an active subblock or an active full block having a low degree of wear-out to another block. Thus, the subblock or the full block from which the valid data is transcribed to another block and that stores only invalid data is released as a free block. As described above, when the data erase operation is performed on the free block and the block is used to store, for example, hot data, the degree of wear-out (the number of erase operations) of the block is likely to increase. Meanwhile, the data erase operation is less likely to be performed on said another block to which the cold data was transcribed. Therefore, the transcription processing unit 143 can level out each of difference in degree of wear-out among active subblocks and difference in degree of wear-out among active full blocks. Note that, in a case where a mode of each full block is fixed, that is, in a case where each full block is dedicatedly used in the subblock mode or in the full block mode, difference in wear may occur between a full block group for the subblock mode and a full block group for the full block mode. Meanwhile, when the mode of each full block is not fixed, the mode of each full block can be switched, so that wear leveling in the entire nonvolatile memory 4 is expected. This can achieve an effect of further effectively using the lifetime of the nonvolatile memory 4.

The address conversion information management unit 144 uses the address conversion management information 52 and manages mapping between each logical address and each physical address in certain management size units. Specifically, the address conversion information management unit 144 updates the address conversion management information 52, for example, so that a logical address designated by a write command received from the host 2 is associated with a physical address to which user data is written in response to the write command. The address conversion information management unit 144 updates the address conversion management information 52 so that, for example, a logical address designated by an unmap command received from the host 2 is not associated with any physical address.

The valid data amount management unit 145 uses the valid data amount management information 53 to manage the amount of valid data stored in a subblock or a full block. Specifically, when data is written to a block, the valid data amount management unit 145 updates the valid data amount management information 53 so that an increase in the valid data amount of the block by the amount of the written data is shown. When update data of a logical address mapped to a physical address of a physical storage location in a block is written (i.e., overwritten) to another block, the valid data amount management unit 145 updates the valid data amount management information 53 so that decrease in the valid data amount of the block by the amount of the update data is shown and increase in the valid data amount of said another block by the amount of the update data is shown. When mapping of a logical address to a physical address of a physical storage location in a block is unmapped, the valid data amount management unit 145 updates the valid data amount management information 53 so that decrease in the valid data amount of the block by the amount of the valid data stored in the physical storage location is shown. When valid data stored in a block is transcribed to another block, the valid data amount management unit 145 updates the valid data amount management information 53 so that decrease in the valid data amount of the transcription source block by the amount of the transcribed valid data is shown. The valid data amount management unit 145 updates the valid data amount management information 53 so that increase in the amount of valid data in the transcription destination block by the amount of the transcribed valid data is shown.

The wear management unit 146 uses the wear management information 54 and manages the degree of wear-out of the full blocks in the nonvolatile memory 4, for example, in subblock units. Specifically, when the data erase operation is performed on a free full block, the wear management unit 146 updates the wear management information 54 so that increase in the degree of wear-out of all subblocks configuring the free full block is shown (for example, increase in the number of erase operations by one). When the data erase operation is performed on a free subblock, the wear management unit 146 updates the wear management information 54 so that increase in the degree of wear-out of the free subblock is shown.

The active block management unit 147 uses the active block management information 55 and manages active full blocks and active subblocks in the nonvolatile memory 4. Specifically, the active block management unit 147 manages a plurality of active full blocks, for example, in a write completion order. The active block management unit 147 manages a plurality of active subblocks, for example, in a write completion order.

The free block management unit 148 uses the free block management information 56 and manages free full blocks and free subblocks in the nonvolatile memory 4. The free block management unit 148 sets a free full block to either the full block mode or the subblock mode. For example, when the data erase operation is performed on a full block (or all subblocks configuring a full block), the free block management unit 148 can switch the mode set for the full block.

When a free full block is allocated as a write destination block or a transcription destination block, the free block management unit 148 may perform the data erase operation on the free full block. When a free subblock is allocated as a write destination block or a transcription destination block, the free block management unit 148 may perform the data erase operation on the free subblock. The free block management unit 148 may perform the data erase operation on a free full block or a free subblock in advance before allocation of the free block as a write destination block or a transcription destination block is determined.

More specific operations of the write command processing unit 141, the read command processing unit 142, the transcription processing unit 143, the address conversion information management unit 144, the valid data amount management unit 145, the wear management unit 146, the active block management unit 147, and the free block management unit 148 will be described later with reference to FIGS. 14 to 18.

Next, the address conversion management information 52, the valid data amount management information 53, the wear management information 54, the active block management information 55, and the free block management information 56 used in the memory system 3 will be described with reference to FIGS. 7 to 13.

### (Address Conversion Management Information 52)

FIG. 7 shows a configuration example of the address conversion management information 52. The address conversion management information 52 is information for managing information on a physical storage location in which data of each of a plurality of logical addresses is stored. The address conversion management information 52 includes, for example, a plurality of entries corresponding to a plurality of logical addresses. Each logical address corresponds to a certain management size unit (management unit granularity). Data of each logical address is stored in either a page in a full block or a page in a subblock configuring a full block. Each entry includes a logical address field, a full block ID field, a subblock ID field, a page ID field, and an in-page offset field.

In an entry corresponding to a certain logical address, the logical address field indicates the certain logical address.

The full block ID field indicates either an ID assigned to a full block (a full block set to the full block mode) in which data of the corresponding logical address is stored, or an ID assigned to a full block (a full block set to the subblock mode) including a subblock in which data of the corresponding logical address is stored. The ID assigned to the full block indicates information that can uniquely identify the full block. The ID assigned to the full block is referred to as a full block ID. When no data is stored at the corresponding logical address, for example, “null” is set in the full block ID field. A logical address storing no data is, for example, a logical address to which the host 2 never requested writing of user data so far, or a logical address for which mapping to a physical storage location where user data was stored is unmapped. A full block having a full block ID of X is also represented as a full block #X.

The subblock ID field indicates an ID assigned to a subblock in which data of the corresponding logical address is stored in a full block including the subblock. In other words, the ID assigned to the subblock is information that can uniquely identify the subblock in the full block including the subblock. The ID assigned to the subblock is referred to as a subblock ID. Specifically, for example, when the number of subblocks configuring a full block is two, a value of either 0 or 1 is set in the subblock ID field. When data of the corresponding logical address is stored in a full block set to the full block mode, for example, “null” is set in the subblock ID field. A subblock having a subblock ID of Y is also represented as a subblock #Y. A subblock #Y in a full block #X is also represented as a subblock #X-Y.

The page ID field indicates an ID assigned to a page in a full block or a subblock in which data of the corresponding logical address is stored. In other words, the ID assigned to the page is information that can uniquely identify the page in the full block or the subblock including the page. Specifically, when data of the corresponding logical address is stored in a full block set to the full block mode, the page ID field indicates the ID assigned to the page in the full block storing the data. When data of the corresponding logical address is stored in a subblock, the page ID field indicates the ID assigned to the page in the subblock storing the data. The ID assigned to the page is referred to as a page ID.

The in-page offset field indicates an offset corresponding to a storage area in a page storing data of the corresponding logical address. An offset is information that can uniquely identify a storage area of a management size unit in the page. An offset corresponding to a storage area of a management size unit in a page is referred to as an in-page offset. Specifically, for example, when a page size is 16 KB and a management size unit is 4 KB, one page includes a storage area of four management size units. Here, for example, a value of 0, 1, 2, or 3 is set in the in-page offset field.

When no data is stored at the corresponding logical address, for example, no value is set in the subblock ID field, the page ID field, and the in-page offset field.

In FIG. 7, for example, a full block ID “50”, a subblock ID “1”, a page ID “7”, and an in-page offset “0” are mapped to a logical address “0”. Here, data of the logical address “0” is stored in a subblock #1 in a full block #50. Similarly, data of a logical address “2” is stored in a subblock #0 in a full block #4. Data of a logical address “5” is stored in a subblock #1 in a full block #33.

For example, a full block ID “1”, a subblock ID “null”, a page ID “18”, and an in-page offset “2” are mapped to a logical address “1”. Here, data of the logical address “1” is stored in a full block #1 set to the full block mode. Similarly, data of a logical address “4” is stored in a full block #5 set to the full block mode.

For example, a full block ID “null” is mapped to a logical address “3”. Here, no data is stored at the logical address “3”. Similarly, no data is stored at any of a logical address “6”, a logical address “7”, and a logical address “8”.

By the above-described configuration, each entry of the address conversion management information 52 can indicate a storage location in a subblock in which data of the corresponding logical address is stored, or a storage location in a full block in which data of the corresponding logical address is stored. Hereinafter, values indicated in the full block ID field, the subblock ID field, the page ID field, and the in-page offset field are collectively referred to as a physical address.

### (Valid Data Amount Management Information 53)

FIG. 8 shows a configuration example of the valid data amount management information 53. The valid data amount management information 53 includes, for example, a plurality of entries corresponding to a plurality of subblocks. Each of the plurality of entries includes, for example, a full block ID field, a subblock ID field, and a valid data amount field.

In an entry corresponding to a certain subblock, the full block ID field indicates an ID of a full block (full block ID) including the certain subblock. For example, when the number of subblocks configuring a full block is two, the valid data amount management information 53 includes two entries to which the same full block ID is set.

The subblock ID field indicates an ID of the corresponding subblock (subblock ID) in a full block including the subblock. Therefore, the corresponding subblock is specified by the full block ID indicated in the full block ID field and the subblock ID indicated in the subblock ID field.

The valid data amount field can indicate an amount of valid data (hereinafter, also referred to as a valid data amount) stored in either the corresponding subblock or the full block including the corresponding subblock. The valid data amount is represented, for example, as the number of pieces of valid data in management size units. Specifically, when the corresponding subblock is provided in a full block set to the subblock mode, the valid data amount of the subblock is set in the valid data amount field. In contrast, when the corresponding subblock is provided in a full block set to the full block mode, among a plurality of entries to which the same full block ID is set, the valid data amount field of one entry is set to the valid data amount of the full block, and the valid data amount fields of the other entries are set to, for example, “null”. The entry in which the valid data amount of the full block is set is, for example, an entry in which the smallest subblock ID is set among a plurality of entries in which the same full block ID is set.

When data is written to a subblock or a full block, the valid data amount in the subblock or the full block is increased by the amount of the written data.

When update data of a logical address mapped to a physical address of a physical storage location in a subblock or a full block is written (i.e., overwritten) to another block, the valid data amount in the subblock or the full block is subtracted by the amount of the update data. When mapping of a logical address to a physical address of a physical storage location in a subblock or a full block is unmapped, the valid data amount in the subblock or the full block is subtracted by the amount of valid data that was stored in the physical storage location. When valid data stored in a subblock or a full block is transcribed to another block, the valid data amount of the transcription source subblock or the transcription source full block is subtracted by the amount of the transcribed valid data. The valid data amount of the transcription destination block is increased by the amount of the transcribed valid data.

In FIG. 8, for example, a valid data amount “43” is set in an entry in which a full block ID “0” and a subblock ID “0” are set. Thus, the valid data amount in a subblock #0 in a full block #0 is indicated as 43. A valid data amount “2” is set in an entry in which the full block ID “0” and a subblock ID “1” are set. Thus, the valid data amount in a subblock #1 in the full block #0 is indicated as 2. The two entries indicate that the valid data amount in the full block #0 is 45 (=43+2).

For example, a valid data amount “56” is set in an entry in which a full block ID “1” and the subblock ID “0” are set. A valid data amount “null” is set in an entry in which the full block ID “1” and the subblock ID “1” are set. Thus, the valid data amount of a full block #1 is indicated as 56. Information that the full block #1 is used in the full block mode can be acquired from the two entries.

By the above-described configuration, each entry of the valid data amount management information 53 can indicate either a valid data amount of the corresponding subblock or a valid data amount of a full block including the corresponding subblock.

### (Wear Management Information 54)

FIG. 9 shows a configuration example of the wear management information 54. The wear management information 54 includes, for example, a plurality of entries corresponding to a plurality of subblocks. Each of the plurality of entries includes, for example, a full block ID field, a subblock ID field, and a degree of wear-out field.

In an entry corresponding to a certain subblock, the full block ID field indicates an ID of a full block (full block ID) including the certain subblock. For example, when the number of subblocks configuring a full block is two, the wear management information 54 includes two entries to which the same full block ID is set.

The subblock ID field indicates an ID of the corresponding subblock (subblock ID) in a full block including the subblock. Therefore, the corresponding subblock is specified by the full block ID indicated in the full block ID field and the subblock ID indicated in the subblock ID field.

The degree of wear-out field indicates the degree of wear-out of the corresponding subblock. The degree of wear-out is represented, for example, by the number of times the data erase operation is performed (the number of erase operations) on the subblock. Here, in response to the data erase operation being performed once on a subblock, the degree of wear-out is increased by 1. When the data erase operation is performed once on a full block, for example, the degree of wear-out of each of a plurality of subblocks configuring the full block increases by 1. Note that any index representing a degree of wear-out of a subblock may be used as the degree of wear-out.

The degree of wear-out of a full block is obtained from the degree of wear-out of each of a plurality of subblocks configuring the full block using any one of the following methods (1) to (3).

(1) Among degrees of wear-out of a plurality of subblocks configuring a full block, the maximum degree of wear-out is obtained as the degree of wear-out of the full block.

(2) An average value of degrees of wear-out of a plurality of subblocks configuring a full block is obtained as the degree of wear-out of the full block.

(3) Among degrees of wear-out of a plurality of subblocks configuring a full block, the minimum degree of wear-out is obtained as the degree of wear-out of the full block.

For example, from the viewpoint of guaranteeing that the degree of wear-out of the full block is equal to or lower than a certain value of the degree of wear-out (for example, the maximum number of P/E cycles), method (1) is preferable.

In FIG. 9, for example, a degree of wear-out “100” is set in an entry in which a full block ID “0” and a subblock ID “0” are set. Thus, the degree of wear-out of a subblock #0 in a full block #0 is indicated as 100. A degree of wear-out “400” is set in an entry in which the full block ID “0” and a subblock ID “1” are set. Thus, the degree of wear-out of a subblock #1 in the full block #0 is indicated as 400. The degree of wear-out of the full block #0 is 400 in the above-mentioned method (1).

By the above-described configuration, each entry of the wear management information 54 indicates the degree of wear-out of the corresponding subblock. By obtaining degrees of wear-out from a plurality of entries in the wear management information 54 to which the same full block ID is set, the degree of wear-out of a full block of the full block ID can be obtained using any of the methods (1) to (3) described above.

### (Active Block Management Information 55)

The active block management information 55 includes, for example, an active full block list 55F and an active subblock list 55S.

FIG. 10 shows a configuration example of the active full block list 55F. The active full block list 55F is, for example, a list in which pieces of information indicating active full blocks (hereinafter, referred to as active full block information) are arranged in the data write completion order. An active full block is a full block in which valid data is stored at least partially after data is written to its terminal. The active full block information includes, for example, an ID of the corresponding full block (full block ID) and an ID of a stream (stream ID) corresponding to the full block.

When data is written to the terminal of a full block (that is, when a full block becomes an active full block), active full block information indicating the full block is registered in (e.g., added to) the active full block list 55F. Active full block information is deleted from the active full block list 55F when the corresponding active full block becomes a free full block not storing valid data, for example.

In the example shown in FIG. 10, the active full block list 55F includes active full block information 311, 312, 313, and 314 corresponding to four active full blocks. The active full block information 311 indicates that a full block having a full block ID of “13” (a full block #13) corresponds to a stream having a stream ID of “5”. The active full block information 312 indicates that a full block having a full block ID of “56” corresponds to a stream having a stream ID of “1”. The active full block information 313 indicates that a full block having a full block ID of “34” corresponds to a stream having a stream ID of “3”. The active full block information 314 indicates that a full block having a full block ID of “27” (a full block #27) corresponds to a stream having a stream ID of “1”. Among the four active full blocks, the full block #13 is the oldest active full block in the data write completion order, and the full block #27 is the newest active full block in the data write completion order.

By the above-described configuration, the active full blocks are managed in the data write completion order using the active full block list 55F.

FIG. 11 shows a configuration example of the active subblock list 55S. The active subblock list 55S is, for example, a list in which pieces of information indicating active subblocks (hereinafter, referred to as active subblock information) are arranged in the data write completion order. An active subblock is a subblock in which valid data is stored at least partially after data is written to its terminal. The active subblock information includes, for example, an ID of a full block (full block ID) including the corresponding subblock, an ID of the corresponding subblock (subblock ID), and an ID of a stream (stream ID) corresponding to the subblock.

When data is written to the terminal of a subblock (that is, when a subblock becomes an active subblock), active subblock information indicating the subblock is registered in (e.g., added to) the active subblock list 55S. Active subblock information is deleted from the active subblock list 55S when the corresponding active subblock becomes a free subblock not storing valid data, for example.

In the example shown in FIG. 11, the active subblock list 55S includes active subblock information 321, 322, 323, and 324 corresponding to four active subblocks. The active subblock information 321 indicates that a subblock having a full block ID of “23” and a subblock ID of “0” (a subblock #23-0) corresponds to a stream having a stream ID of “1”. The active subblock information 322 indicates that a subblock having a full block ID of “5” and a subblock ID of “1” corresponds to a stream having a stream ID of “2”. The active subblock information 323 indicates that a subblock having a full block ID of “14” and a subblock ID of “1” corresponds to a stream having a stream ID of “5”. The active subblock information 324 indicates that a subblock having a full block ID of “42” and a subblock ID of “0” (a subblock #42-0) corresponds to a stream having a stream ID of “3”. Among the four active subblocks, the subblock #23-0 is the oldest active subblock in the data write completion order, and the subblock #42-0 is the newest active subblock in the data write completion order.

By the above-described configuration, the active subblocks are managed in the data write completion order using the active subblock list 55S.

The active full block list 55F or the active subblock list 55S may be managed by a plurality of lists for each of corresponding stream IDs instead of being managed by a single list as shown in FIGS. 10 and 11.

### (Free Block Management Information 56)

The free block management information 56 includes, for example, a free full block list 56F and a free subblock list 56S.

FIG. 12 shows a configuration example of the free full-block list 56F. The free full block list 56F is, for example, a list in which pieces of information indicating free full blocks (hereinafter, referred to as free full block information) are arranged in an order of the degree of wear-out. The free full block is a full block not storing valid data. The free full block information includes, for example, an ID of the corresponding full block (full block ID).

The free full block information is registered in (e.g., added to) the free full block list 56F based on the degree of wear-out of the corresponding full block. For example, when valid data is not stored in the full block due to overwriting, unmap, or transcription (for example, garbage collection), that is, when an active full block becomes a free full block, the free full block information indicating the corresponding full block is registered in the free full block list 56F. Free full block information is deleted from the free full block list 56F, for example, when the corresponding free full block is selected as a write destination block (or a transcription destination block).

In the example shown in FIG. 12, the free full block list 56F includes free full block information 351, 352, 353, and 354 corresponding to four free full blocks. The free full block information 351 indicates a full block having a full block ID of “31” (a full block #31). The free full block information 352 indicates a full block having a full block ID of “65”. The free full block information 353 indicates a full block having a full block ID of “43”. The free full block information 354 indicates a full block having a full block ID of “72” (a full block #72). Among the four free full blocks, the full block #31 is a free full block having the highest degree of wear-out, and the full block #72 is a free full block having the lowest degree of wear-out.

By the above-described configuration, the free full blocks are managed in the order of the degree of wear-out using the free full block list 56F. Hereinafter, registration of free full block information in the free full block list 56F is also referred to as registration of a free full block in the free full block list 56F. Deletion of free full block information from the free full block list 56F is also referred to as deletion of a free full block from the free full block list 56F.

FIG. 13 shows a configuration example of the free subblock list 56S. The free subblock list 56S is, for example, a list in which pieces of information indicating free subblocks (hereinafter, referred to as free subblock information) are arranged in the order of the degree of wear-out. The free subblock is a subblock not storing valid data. The free subblock information includes, for example, an ID of a full block (full block ID) including the corresponding subblock, and an ID of the corresponding subblock (subblock ID).

The free subblock information is registered in (e.g., added to) the free subblock list 56S based on the degree of wear-out of the corresponding subblock. For example, when valid data is not stored in the subblock due to overwriting, unmap, and transcription, that is, when an active subblock becomes a free subblock, free subblock information indicating the corresponding subblock is registered in the free subblock list 56S. Free subblock information is deleted from the free subblock list 56S, for example, when the corresponding free subblock is selected as a write destination block (or a transcription destination block).

In the example shown in FIG. 13, the free subblock list 56S includes free subblock information 361, 362, 363, and 364 corresponding to four free subblocks. The free subblock information 361 indicates a subblock having a full block ID of “32” and a subblock ID of “1” (a subblock #32-1). The free subblock information 362 indicates a subblock having a full block ID of “50” and a subblock ID of “0”. The free subblock information 363 indicates a subblock having a full block ID of “41” and a subblock ID of “0”. The free subblock information 364 indicates a subblock having a full block ID of “24” and a subblock ID of “1” (a subblock #24-1). Among the four free subblocks, the subblock #32-1 is a free subblock having the highest degree of wear-out, and the subblock #24-1 is a free subblock having the lowest degree of wear-out.

By the above-described configuration, the free subblocks are managed in the order of the degree of wear-out using the free subblock list 56S. Hereinafter, registration of free subblock information in the free subblock list 56S is also referred to as registration of a free subblock in the free subblock list 56S. Deletion of free subblock information from the free subblock list 56S is also referred to as deletion of a free subblock from the free subblock list 56S.

Next, with reference to FIGS. 14 to 18, specific operations of the write command processing unit 141, the read command processing unit 142, the transcription processing unit 143, the address conversion information management unit 144, the valid data amount management unit 145, the wear management unit 146, the active block management unit 147, and the free block management unit 148 will be described. The operations performed by the processing units and the management units include, for example, a host write operation, a sub-full block transcription operation, a refresh operation, a first free block allocation operation, a second free block allocation operation, and a wear leveling operation. The operations will be explained in order.

### (Host Write Operation and Sub-Full Block Transcription Operation)

FIG. 14 shows an example of the host write operation and the sub-full block transcription operation.

The host write operation is an operation of writing, in response to a write command that designates one of a plurality of streams 60, user data to be written into a subblock allocated to the designated stream. In the memory system 3, for example, host write operations of the same number as the number of streams used by the host 2 can be executed in parallel by multi-threads. Therefore, the same number of subblocks as the number of streams being used are allocated to the streams as write destination blocks.

The sub-full block transcription operation is an operation of transcribing valid data of an amount of a full block capacity from subblocks to a full block for each stream 60. The sub-full block transcription operation is executed at a predetermined timing after a total of valid data amount of a certain stream 60 stored in each of the plurality of subblocks becomes equal to or greater than the full block capacity. When the transcription operation is executed, valid data of the stream 60 is transcribed from the plurality of subblocks to a full block by the amount of the full block capacity. Note that before the transcription operation is executed, for example, a part of user data written to the transcription source subblock in the host write operation may be invalidated by overwriting, unmap, or the like.

In the memory system 3, operations of transcribing valid data from a transcription source block to a transcription destination block (hereinafter, also referred to as a data transcription operation) including sub-full block transcription operations are executed, for example, serially (that is, one by one). Here, the number of blocks to be allocated as a transcription destination block at once is one. Therefore, the block allocated as the transcription destination block hardly affects overprovisioning capacity of the memory system 3. On the other hand, in the memory system 3, a plurality of data transcription operations may be executed in parallel by multi-threads as long as the number of transcription destination blocks allocated at once does not significantly affect overprovisioning capacity of the memory system 3.

The host write operation and the sub-full block transcription operation are performed by, for example, the write command processing unit 141, the transcription processing unit 143, the address conversion information management unit 144, the valid data amount management unit 145, the active block management unit 147, and the free block management unit 148.

FIG. 14 illustrates an example in which the plurality of streams 60 are a zeroth stream 600, a first stream 601, a third stream 603, and a fourth stream 604. Subblocks 611, 612, 621, and 622 are allocated as write destination blocks respectively to the zeroth stream 600, the first stream 601, the third stream 603, and the fourth stream 604. The subblocks 611 and 612 configure a full block 61. The subblocks 621 and 622 configure a full block 62.

The write command processing unit 141 writes, in response to a write command received from the host 2, user data to be written into a subblock (write destination block) allocated to a stream designated by the write command. Specifically, the write command processing unit 141 writes user data corresponding to a write command that designates the zeroth stream 600 into the subblock 611. The write command processing unit 141 writes user data corresponding to a write command that designates the first stream 601 into the subblock 612. The write command processing unit 141 writes user data corresponding to a write command that designates the third stream 603 into the subblock 621. The write command processing unit 141 writes the user data corresponding to a write command that designates the fourth stream 604 into the subblock 622.

In response to the user data being written into the write destination block, the address conversion information management unit 144 and the valid data amount management unit 145 update information managed by each unit.

Specifically, the address conversion information management unit 144 updates the address conversion management information 52 and associates a logical address of the written user data with a physical storage location at which the user data is written. For example, the address conversion information management unit 144 updates an entry of the address conversion management information 52 corresponding to the logical address of the written user data in management size units and associates the logical address with a physical address indicating the physical storage location at which the user data is written (for example, a physical storage location in the subblock 611, 612, 621, or 622).

The valid data amount management unit 145 adds an amount of the user data written in a write destination block to the valid data amount in an entry corresponding to the write destination block. For example, the valid data amount management unit 145 adds the amount of the user data written in the subblock 611 to the valid data amount indicated in an entry corresponding to the subblock 611 in the valid data amount management information 53. When the logical address of the written user data is associated, in the address conversion management information 52, with a physical address indicating a physical storage location in which previous data is stored, the valid data amount management unit 145 subtracts, in the valid data amount management information 53, the amount of the written user data from the valid data amount indicated in an entry corresponding to a full block or a subblock including the physical storage location.

In response to the user data being written to the terminal of any of the subblocks 611, 612, 621, and 622, the active block management unit 147 manages the subblock as an active subblock 32. Specifically, the active block management unit 147 registers active subblock information indicating a subblock in which user data is written to its terminal in the active subblock list 55S.

In the example shown in FIG. 14, the active block management unit 147 manages each of subblocks 631, 632, 641, 642, 651, 652, . . . , as an active subblock 32. The subblocks 631 and 632 configure a full block 63. The subblocks 641 and 642 configure a full block 64. The subblocks 651 and 652 configure a full block 65. The subblocks 631 and 642 are allocated to the zeroth stream 600. The subblock 651 is allocated to the first stream 601. The subblock 641 is allocated to the third stream 603. The subblocks 632 and 652 are allocated to the fourth stream 604.

More specifically, the active block management unit 147 manages active subblock information indicating each of the subblocks 631, 632, 641, 642, 651, 652, . . . using the active subblock list 55S. For example, the active subblock information of the subblock 631 includes the full block ID of the full block 63, the subblock ID of the subblock 631 in the full block 63, and the stream ID of the zeroth stream 600 to which the subblock 631 is allocated.

Data stored in the active subblock 32 includes at least valid data. The data stored in the active subblock 32 may include invalid data. The valid data stored in the active subblock 32 may be invalidated, for example, by overwriting, unmap, or transcription, thereby becoming invalid data. Here, it is assumed that all pieces of data stored in the subblocks 631, 632, 641, 642, 651, and 652 are valid data.

When valid data of an amount of a full block capacity is stored in a plurality of subblocks allocated to a certain stream 60, the transcription processing unit 143 transcribes valid data of the amount of the full block capacity from the plurality of subblocks to one free full block 35. In other words, the transcription processing unit 143 performs a transcription process in which a plurality of subblocks are set as transcription source blocks 33 and the free full block 35 is set as a transcription destination block 34. A timing of executing the transcription process is freely selected in a period while valid data of the amount of the full block capacity is stored in a plurality of subblocks allocated to a certain stream 60. The subblocks allocated to the certain stream 60 may include not only the active subblock 32 allocated to the stream 60 but also a write destination block being allocated to the stream 60.

The transcription processing unit 143 selects a free full block 35 having a low degree of wear-out as the transcription destination block 34, for example, using the free full block list 56F. Specifically, the transcription processing unit 143 classifies, for example, a plurality of free full blocks 35 registered in the free full block list 56F into a plurality of groups according to the degree of wear-out. Then, the transcription processing unit 143 selects one free full block 35 as the transcription destination block 34 from one or more groups having a lower degree of wear-out among the plurality of groups. In other words, the transcription processing unit 143 may select a free full block 35 having a relatively low degree of wear-out as the transcription destination block 34.

In the example shown in FIG. 14, the subblocks 631 and 642 allocated to the zeroth stream 600 store valid data of the amount of the full block capacity. The subblocks 632 and 652 allocated to the fourth stream 604 store valid data of the amount of the full block capacity. In other words, in the example shown in FIG. 14, it is assumed that no data in these subblocks is invalidated by overwriting, unmap, or transcription and becomes invalid data.

Here, when valid data of the amount of the full block capacity is stored in the subblocks 631 and 642 allocated to the zeroth stream 600, the transcription processing unit 143 selects the subblocks 631 and 642 as the transcription source blocks 33. The transcription processing unit 143 selects a free full block 66 having a low degree of wear-out as the transcription destination block 34 using the free full block list 56F. Then, the transcription processing unit 143 transcribes the valid data stored in the subblocks 631 and 642 (transcription source blocks 33) to the free full block 66 (transcription destination block 34).

When valid data of the amount of the full block capacity is stored in the subblocks 632 and 652 allocated to the fourth stream 604, the transcription processing unit 143 selects the subblocks 632 and 652 as the transcription source blocks 33. The transcription processing unit 143 selects a free full block 67 having a low degree of wear-out as the transcription destination block 34 using the free full block list 56F. Then, the transcription processing unit 143 transcribes the valid data stored in the subblocks 632 and 652 into the free full block 67.

Accordingly, each of the subblocks 631, 632, 642, and 652 becomes a free subblock in which valid data is not stored. Therefore, each of the subblocks 631, 632, 642, and 652 can be reused after undergoing the data erase operation. Since both the subblocks 631 and 632 become free subblocks, the subblocks 631 and 632 may be reused as the full block 63 after undergoing the data erase operation.

In response to valid data of the amount of the full block capacity being transcribed from the transcription source block 33 to the transcription destination block 34, the address conversion information management unit 144, the valid data amount management unit 145, the active block management unit 147, and the free block management unit 148 update information managed by each unit.

Specifically, the address conversion information management unit 144 updates the address conversion management information 52 and associates a logical address of transcribed valid data with a physical storage location to which the valid data is transcribed. For example, the address conversion information management unit 144 updates an entry of the address conversion management information 52 corresponding to the logical address of the valid data of the amount of the management size unit transcribed from the subblock 631 and associates the logical address with a physical address indicating the physical storage location to which the valid data is transcribed (that is, a physical storage location in the full block 66).

The valid data amount management unit 145 subtracts, from the valid data amount indicated in the entry corresponding to the transcription source block 33 in the valid data amount management information 53, the amount of valid data transcribed from the transcription source block 33 to the transcription destination block 34. For example, the valid data amount management unit 145 subtracts, from the valid data amount indicated in the entry corresponding to the subblock 631 in the valid data amount management information 53, the amount of valid data transcribed from the subblock 631 to the full block 66.

The valid data amount management unit 145 adds, to the valid data amount in the entry corresponding to the transcription destination block 34, the amount of valid data transcribed from the transcription source block 33 to the transcription destination block 34. For example, the valid data amount management unit 145 adds, to the valid data amount indicated in the entry corresponding to the full block 66 in the valid data amount management information 53, the amount of valid data transcribed from the subblocks 631 and 642 to the full block 66.

The active block management unit 147 deletes, from the active block management information 55, the transcription source block 33 that becomes a free block by transcription of valid data. Specifically, the active block management unit 147 deletes, from the active subblock list 55S, the transcription source block 33 that becomes a free subblock by transcription of valid data. For example, the active block management unit 147 deletes, from the active subblock list 55S, the subblocks 631, 632, 642, and 652, which become free subblocks by transcription of valid data.

The free block management unit 148 adds, to the free block management information 56, the transcription source block 33 that becomes a free block by transcription of valid data. Specifically, the free block management unit 148 adds, to the free subblock list 56S, the transcription source block 33 that becomes a free subblock by transcription of valid data, that is, the transcription source block 33 deleted from the active subblock list 55S. For example, the free block management unit 148 adds, to the free subblock list 56S, the subblocks 631, 632, 642, and 652 that become free subblocks by transcription of valid data. The free block management unit 148 may add, to the free full block list 56F instead of adding the subblocks 631 and 632 to the free subblock list 56S, the full block 63 including the subblocks 631 and 632.

The free block management unit 148 deletes, from the free block management information 56, the free block allocated as the transcription destination block 34. Specifically, the free block management unit 148 deletes, from the free full block list 56F, the free full block allocated as the transcription destination block 34. For example, the free block management unit 148 deletes, from the free full block list 56F, the free full blocks 66 and 67 allocated as the transcription destination blocks 34.

When the data erase operation is performed on the free full block 35 (for example, free full block 66 or 67) before the free full block 35 is allocated as the transcription destination block 34, the wear management unit 146 increases, in the wear management information 54, a degree of wear-out indicated in an entry corresponding to the free full block 35. More specifically, the wear management unit 146 increases, in the wear management information 54, the degree of wear-out indicated in the entry corresponding to each of the plurality of subblocks configuring the free full block 35.

As described above, by the host write operation, the write command processing unit 141 writes user data corresponding to a write command into the subblock 611, 612, 621, or 622 allocated to a stream designated by the write command. Accordingly, the subblock 611, 612, 621, or 622 is used as a write destination for the user data in response to the write command. In this way, for example, the write command processing unit 141 can reduce a total storage capacity of the write destination blocks allocated to the plurality of streams 60, thereby preventing decrease in overprovisioning capacity of the memory system 3.

Note that, if the sub-full block transcription operation is executed immediately after valid data of an amount equal to or greater than the full block capacity is stored in the subblock allocated to each stream 60, the transcription operation is performed in a state immediately after the host write operation, that is, in a state in which user data is not yet invalidated by overwriting, unmap, or the like, raising concerns about increase in a write amplification factor (WAF). The WAF is a value obtained by dividing data amount actually written to the nonvolatile memory 4 by data amount written to the nonvolatile memory 4 in response to a request from the host 2.

Meanwhile, if the sub-full block transcription operation is executed not immediately after but at a predetermined timing after valid data of the amount equal to or greater than the full block capacity is stored in the subblock allocated to each stream 60, user data is likely to be invalidated by overwriting, unmap, or the like before the transcription process actually begins. Here, transcribed data amount is the same as the full block capacity, but since more transcription source subblocks are likely allocated as free subblocks, increase in the WAF can be prevented. As such, the transcription processing unit 143 can determine the timing of performing the transcription process while considering a balance with the WAF.

Immediately after starting to use the memory system 3, the number of active full blocks and active subblocks is zero. For example, when the mode of each full block is not fixed, and the sub-full block transcription operation is made to wait until a predetermined timing, only the number of active subblocks increases by the host write operation until the predetermined timing. After the predetermined timing, transition of the mode of blocks can be expected such that the number of active full blocks relatively increases by the sub-full block transcription operation. Further, since information on a block, which is the transcription destination of the valid data in the sub-full block transcription operation, is managed on the full block basis, management of the information on the block (for example, valid data amount and degree of wear-out) and control based on the information on the block (for example, wear leveling and garbage collection) become easier than management of information on a plurality of subblocks, in which valid data was stored, on the subblock basis.

Therefore, due to the host write operation and the sub-full block transcription operation, the memory system 3 can efficiently use the nonvolatile memory 4.

Note that, in the memory system 3, subblocks are used as first-in first-out (FIFO) memories for the host write operation. Here, when the host write amount of each stream 60 is uniform, variation in the degree of wear-out between subblocks can be reduced.

If valid data of an amount less than the full block capacity is transcribed from a subblock allocated to a stream 60 to a full block, and a write command designating the stream 60 is not received from the host 2 thereafter, a situation occurs in which user data is not written into a memory area in the transcription destination full block. At worst, the situation corresponds to consumption of overprovisioning capacity of approximately the full block capacity for each stream 60. Therefore, if valid data of the amount less than the full block capacity is transcribed from a subblock to a full block, overprovisioning capacity is reduced similar to when a full block instead of a subblock is allocated as the write destination block for a host write.

Therefore, in the sub-full block transcription operation of the embodiment, valid data of the amount of the full block capacity is transcribed from a subblock to a full block for each stream 60. In other words, for each stream 60, valid data is stored in the subblock until the valid data amount reaches the full block capacity so that it is possible to prevent substantial consumption of overprovisioning capacity in the memory system 3.

### (Refresh Operation)

FIG. 15 shows an example of the refresh operation. The refresh operation is an operation of transcribing valid data stored in an active subblock 32, which has a lower degree of wear-out among a plurality of subblocks configuring one full block in which a wear difference is large, to another block. The refresh operation is performed by, for example, the transcription processing unit 143, the address conversion information management unit 144, the valid data amount management unit 145, the active block management unit 147, and the free block management unit 148.

Similar to the host write operation and the sub-full block transcription operation described above with reference to FIG. 14, subblocks 711, 712, 721, and 722 are allocated to the plurality of streams 600, 601, 603, and 604 as write destination blocks. The subblocks 711 and 712 configure a full block 71. The subblocks 721 and 722 configure a full block 72. User data to be written in response to a write command received from the host 2 is written to the subblock 711, 712, 721, or 722 allocated to the stream 600, 601, 603, or 604 designated by the write command.

In response to the user data being written to the terminal of any one of the subblocks 711, 712, 721, and 722, the active block management unit 147 manages the subblock as an active subblock 32. Specifically, the active block management unit 147 registers, in the active subblock list 55S, active subblock information indicating a subblock in which user data is written to its terminal.

In the example shown in FIG. 15, the active block management unit 147 manages each of subblocks 731, 732, 741, 742, 751, 752, . . . , as an active subblock 32 using the active subblock list 55S. The subblocks 731 and 732 configure a full block 73. The subblocks 741 and 742 configure a full block 74. The subblocks 751 and 752 configure a full block 75. The subblocks 731 and 742 are allocated to the zeroth stream 600. The subblock 751 is allocated to the first stream 601. The subblock 741 is allocated to the third stream 603. The subblocks 732 and 752 are allocated to the fourth stream 604.

When a wear difference between two subblocks configuring one full block exceeds a first threshold value, the transcription processing unit 143 performs, by using the wear management information 54, the refresh operation of transcribing valid data from one subblock in the two subblocks having a lower degree of wear-out to another block. Specifically, for example, when a difference obtained by subtracting the degree of wear-out of the subblock 732 from the degree of wear-out of the subblock 731 exceeds the first threshold value, the transcription processing unit 143 transcribes valid data stored in the subblock 732 to another block (for example, a data-erased subblock 761). For example, when a difference obtained by subtracting the degree of wear-out of the subblock 731 from the degree of wear-out of the subblock 732 exceeds the first threshold value, the transcription processing unit 143 transcribes valid data stored in the subblock 731 to another block. A timing at which the refresh operation is performed is freely selected in a period while a wear difference between two subblocks configuring one full block exceeds the first threshold value.

In FIG. 15, it is assumed that a total amount of valid data stored in the subblocks allocated to the third stream 603 continues to be less than the full block capacity. That is, for example, the amount of user data to be written into the nonvolatile memory 4 in response to a write command designating the third stream 603 is assumed to be less than the amount of user data to be written into the nonvolatile memory 4 in response to a write command designating each of the other streams 600, 601, and 604. Here, for example, reliability of valid data stored in the subblock 741 allocated to the third stream 603 may deteriorate due to the data erase operation and the data write operation on the subblock 742 paired with the subblock 741. Therefore, when a difference between the degree of wear-out of the subblock 742 and the degree of wear-out of the subblock 741 (wear difference) exceeds the first threshold value, for example, the transcription processing unit 143 transcribes at least valid data in the subblock 741 to a free subblock 762. In other words, the transcription processing unit 143 performs a transcription process in which the subblock 741 is set as the transcription source block 33 and the free subblock 762 is set as the transcription destination block 34.

Accordingly, the subblock 741 becomes the free subblock 36 in which valid data is not stored. Therefore, the subblock 741 is reusable after undergoing the data erase operation.

Note that the transcription processing unit 143 selects the free subblock 36 having a low degree of wear-out (for example, the free subblock 762) as the transcription destination block 34, for example, using the free subblock list 56S. Specifically, the transcription processing unit 143 classifies, for example, a plurality of free subblocks 36 registered in the free subblock list 56S into a plurality of groups according to the degree of wear-out. Then, the transcription processing unit 143 selects one free subblock 36 as the transcription destination block 34 from one or more groups having a lower degree of wear-out among the plurality of groups. In other words, the transcription processing unit 143 may select the free subblock 36 having a relatively low degree of wear-out as the transcription destination block 34.

The transcription processing unit 143 may select the free subblock 36 having a high degree of wear-out as the transcription destination block 34 using the free subblock list 56S. The reason is that, for example, the amount of user data to be written by designating the third stream 603 is expected to continue to be smaller from now than the amount of user data to be written by designating each of the other streams 600, 601, and 604. Specifically, the transcription processing unit 143 selects one free subblock 36 as the transcription destination block 34 from one or more groups having a higher degree of wear-out among the plurality of groups classified according to the degree of wear-out. In other words, the transcription processing unit 143 may select the free subblock 36 having a relatively high degree of wear-out as the transcription destination block 34.

When valid data is transcribed from the transcription source block 33 to the transcription destination block 34 (here, from the subblock 741 to the free subblock 762), the address conversion information management unit 144, the valid data amount management unit 145, the active block management unit 147, and the free block management unit 148 update information managed by each unit by an operation similar to, for example, the sub-full block transcription operation described above with reference to FIG. 14.

When the data erase operation is performed on a free subblock 36 (for example, free subblock 762) before the subblock is allocated as a transcription destination block 34, the wear management unit 146 increases the degree of wear-out indicated in the entry corresponding to the free subblock 36 in the wear management information 54.

When a wear difference between two subblocks configuring one full block exceeds the first threshold value, the transcription processing unit 143 may determine whether valid data of an amount of the full block capacity is stored in a plurality of blocks allocated to a stream corresponding to a subblock having the lower degree of wear-out using the wear management information 54. When valid data of the amount of the full block capacity is stored in the plurality of blocks allocated to the stream corresponding to the subblock having the lower degree of wear-out, the transcription processing unit 143 may transcribe valid data of the amount of the full block capacity from the plurality of blocks to the free full block 35.

### (First Free Block Allocation Operation)

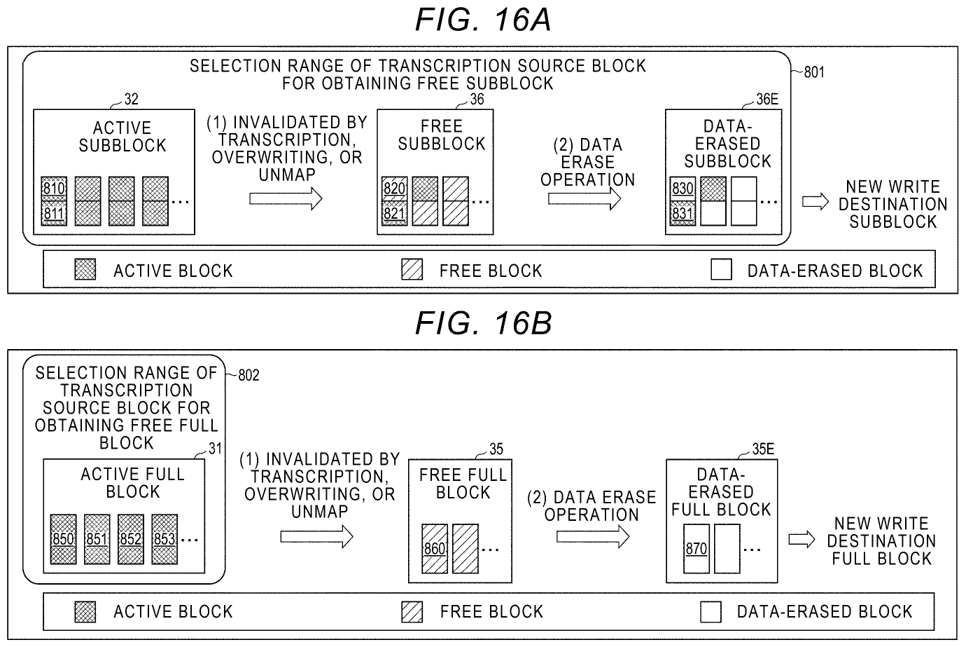

FIG. 16A shows an example of the first free block allocation operation including a free subblock allocation operation, and FIG. 16B shows an example of the first free block allocation operation including a free full block allocation operation, when the mode of each full block is fixed. The first free block allocation operation is an operation for obtaining free subblocks of the number equal to or greater than the second threshold value and free full blocks of the number equal to or greater than the third threshold value, when the mode of each full block is fixed.

As described above, a full block can be used either as subblocks or as a full block. In a full block used as subblocks, each of the plurality of subblocks in the full block is used individually. In a full block used as a full block, the entire full block is used as a whole.

When the mode of each full block is fixed, for example, in all full blocks managed in the memory system 3, the number of full blocks used as subblocks and the number of full blocks used as a full block are defined in advance. For example, the number of full blocks used as subblocks is determined based on a host write amount expected in a lifetime guaranteed by the memory system 3, and the number of the other full blocks is determined as the number of full blocks used as a full block.

To increase durability, the subblocks may be used as pseudo single level cell (pSLC) blocks. The pSLC block is a block capable of storing two or more bits of data per memory cell, but is used as an SLC block in which one bit of data is stored per memory cell.

The first free block allocation operation is performed by, for example, the transcription processing unit 143, the address conversion information management unit 144, the valid data amount management unit 145, the wear management unit 146, the active block management unit 147, and the free block management unit 148. The first free block allocation operation includes a free subblock allocation operation and a free full block allocation operation.

### (Free Subblock Allocation Operation)

The free subblock allocation operation is an operation for making the number of free subblocks equal to or greater than the second threshold value. The number of free subblocks is the total number of free subblocks 36 and data-erased subblocks 36E in the nonvolatile memory 4. The data-erased subblock 36E is a free subblock on which the program operation is not performed after the data erase operation is completed. The free subblock 36 and the data-erased subblock 36E may be collectively referred to as a free subblock.

As shown in FIG. 16A, valid data stored in the active subblock 32 is invalidated by, for example, any of transcription, overwriting, or unmap. The active subblock 32 that no longer stores any valid data due to invalidation becomes a free subblock 36 ((1) in FIG. 16A). Then, the free subblock 36 undergoes the data erase operation and becomes a data-erased subblock 36E ((2) in FIG. 16A). Specifically, for example, an active subblock 810 becomes a free subblock 820 by invalidation. The free subblock 820 then undergoes the data erase operation and becomes a data-erased subblock 830.

For example, when the number of free subblocks is smaller than the second threshold value, the transcription processing unit 143 selects the active subblock 32 having a smaller valid data amount as the transcription source block 33, based on a valid data amount of each of the plurality of active subblocks 32, and obtains a new free subblock 36. The active subblock 32 selected as the transcription source block 33 is one of two paired active subblocks 32, a subblock paired with a free subblock 36, or a subblock paired with a data-erased subblock 36E. Therefore, a selection range 801 of the transcription source block 33 for obtaining a new free subblock 36 includes two paired active subblocks 32, an active subblock 32 paired with a free subblock 36, and an active subblock 32 paired with a data-erased subblock 36E.

In FIG. 16A, one of the two paired active subblocks 32 is, for example, one of the two paired active subblocks 810 and 811. The active subblock 32 paired with the free subblock 36 is, for example, an active subblock 821 paired with the free subblock 820. The active subblock 32 paired with the data-erased subblock 36E is, for example, an active subblock 831 paired with the data-erased subblock 830.

The transcription processing unit 143 selects, for example, the active subblock 32 having the smallest valid data amount as the transcription source block 33 from the active subblocks 32 registered in the active subblock list 55S (that is, the active subblocks 32 in the selection range 801). Alternatively, the transcription processing unit 143 may classify the active subblocks 32 registered in the active subblock list 55S into a plurality of groups according to the valid data amount. Here, the transcription processing unit 143 selects one active subblock 32 as the transcription source block 33 from one or more groups having a smaller valid data amount among the plurality of groups. In other words, the transcription processing unit 143 may select the active subblock 32 having a relatively small valid data amount as the transcription source block 33. The active subblock 32 having the relatively small valid data amount is, for example, an active subblock having a valid data amount less than an average valid data amount of all active subblocks 32 by a first value or more.

Then, the transcription processing unit 143 transcribes at least valid data in the selected transcription source block 33 to the transcription destination block 34. The transcription destination block 34 is, for example, a data-erased subblock 36E or a data-erased full block 35E. Thus, the transcription source block 33 becomes the free subblock 36, and becomes reusable as a new write destination (or transcription destination) subblock after undergoing the data erase operation.

### (Free Full Block Allocation Operation)

The free full block allocation operation is an operation for making the number of free full blocks equal to or greater than the third threshold value. The number of free full blocks is the total number of the free full blocks 35 and the data-erased full blocks 35E in the nonvolatile memory 4. The data-erased full block 35E is a free full block on which the program operation is not performed after the data erase operation is completed. The free full block 35 and the data-erased full block 35E may be collectively referred to as a free full block.

As shown in FIG. 16B, valid data stored in the active full block 31 is invalidated by, for example, any of transcription, overwriting, or unmap. The active full block 31 that no longer stores any valid data due to invalidation becomes a free full block 35 ((1) in FIG. 16B). Then, the free full block 35 undergoes the data erase operation and becomes a data-erased full block 35E ((2) in FIG. 16B). Specifically, for example, an active full block 850 becomes a free full block 860 by invalidation. The free full block 860 then undergoes the data erase operation and becomes a data-erased full block 870.

For example, when the number of free full blocks is less than the third threshold value, the transcription processing unit 143 selects the active full block 31 having a smaller valid data amount as the transcription source block 33, based on the valid data amount in each of the plurality of active full blocks 31, and obtains a new free full block 35. A selection range 802 of the transcription source block 33 for obtaining a new free full block 35 includes, for example, a plurality of active full blocks 31. In the example shown in FIG. 16B, the selection range 802 includes active full blocks 850, 851, 852, 853, . . . .

The transcription processing unit 143 selects, for example, the active full block 31 having the smallest valid data amount as the transcription source block 33 from the active full blocks 31 registered in the active full block list 55F (that is, the active full block 31 in the selection range 802). Alternatively, the transcription processing unit 143 may classify the active full blocks 31 registered in the active full block list 55F into a plurality of groups according to the valid data amount. Here, the transcription processing unit 143 selects one active full block 31 as the transcription source block 33 from one or more groups having a smaller valid data amount among the plurality of groups. In other words, the transcription processing unit 143 may select the active full block 31 having a relatively small valid data amount as the transcription source block 33. The active full block 31 having the relatively small valid data amount is, for example, an active full block having a valid data amount less than an average valid data amount of all active full blocks 31 by a second value or more.

Then, the transcription processing unit 143 transcribes at least valid data in the selected transcription source block 33 to the transcription destination block 34. The transcription destination block 34 is, for example, a data-erased subblock 36E or a data-erased full block 35E. Thus, the transcription source block 33 becomes the free full block 35, and becomes reusable as a new write destination (or transcription destination) full block after undergoing the data erase operation.

When valid data is transcribed from the transcription source block 33 to the transcription destination block 34, the address conversion information management unit 144, the valid data amount management unit 145, the wear management unit 146, the active block management unit 147, and the free block management unit 148 update information managed by each unit by an operation similar to, for example, the sub-full block transcription operation described above with reference to FIG. 14.

By the above-described first free block allocation operation, the memory system 3 can obtain free subblocks of the number equal to or greater than the second threshold value and free full blocks of the number equal to or greater than the third threshold value when the mode of each full block is fixed.

### (Second Free Block Allocation Operation)

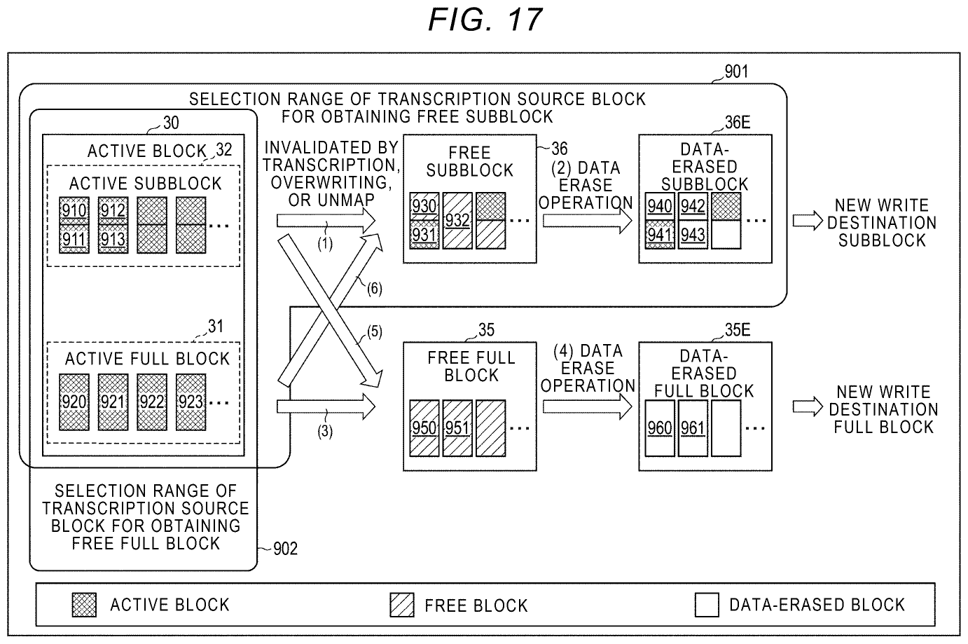

FIG. 17 shows an example of the second free block allocation operation when the mode of each full block is not fixed. The second free block allocation operation is an operation for obtaining free subblocks of the number equal to or greater than the second threshold value and free full blocks of the number equal to or greater than the third threshold value when the mode of each full block is not fixed. The second free block allocation operation is performed by, for example, the transcription processing unit 143, the address conversion information management unit 144, the valid data amount management unit 145, the wear management unit 146, the active block management unit 147, and the free block management unit 148. The second free block allocation operation includes a free subblock allocation operation and a free full block allocation operation. The free subblock allocation operation is an operation for making the number of free subblocks equal to or greater than the second threshold value. The free full block allocation operation is an operation for making the number of free full blocks equal to or greater than the third threshold value.

As shown in FIG. 17, valid data stored in an active block 30 is invalidated by, for example, any of transcription, overwriting, or unmap. The active block 30 is either the active full block 31 or the active subblock 32.

The active subblock 32 that no longer stores any valid data due to invalidation becomes a free subblock 36 ((1) in FIG. 17). Then, the free subblock 36 undergoes the data erase operation and becomes a data-erased subblock 36E ((2) in FIG. 17). Specifically, for example, an active subblock 910 becomes a free subblock 930 by invalidation. The free subblock 930 then undergoes the data erase operation and becomes a data-erased subblock 940.

The active full block 31 that no longer stores any valid data due to invalidation becomes a free full block 35 ((3) in FIG. 17). Then, the free full block 35 undergoes the data erase operation and becomes a data-erased full block 35E ((4) in FIG. 17). Specifically, for example, an active full block 920 becomes a free full block 950 by invalidation. The free full block 950 then undergoes the data erase operation and becomes a data-erased full block 960.

Two paired active subblocks 32 that no longer store valid data due to invalidation can become a free full block 35 ((5) in FIG. 17). Then, the free full block 35 undergoes the data erase operation and becomes the data-erased full block 35E ((4) in FIG. 17). Specifically, for example, two paired active subblocks 912 and 913 can become a free full block 951 by invalidation. The free full block 951 then undergoes the data erase operation and becomes a data-erased subblock 961.

An active full block 31 that no longer stores any valid data due to invalidation can become two free subblocks 36 ((6) in FIG. 17). In other words, two free subblocks 36 can be obtained from the active full block 31 that no longer stores any valid data. Then, two free subblocks 36 undergo the data erase operation and become two data-erased subblocks 36E ((2) in FIG. 17). Specifically, for example, the active full block 921 becomes a free full block 932 equivalent to two free subblocks 36 by invalidation. The free full block 932 then undergoes the data erase operation and becomes two data-erased full blocks 942 and 943.

### (Free Subblock Allocation Operation)

For example, when the number of free subblocks is smaller than the second threshold value, the transcription processing unit 143 selects an active subblock 32 or an active full block 31 having a smaller valid data amount as the transcription source block 33 and obtains a new free subblock 36, based on the valid data amount of each of the plurality of active subblocks 32 and the valid data amount in each subblock of each of the plurality of active full blocks 31. The active subblock 32 that may be selected as the transcription source block 33 is one of two paired active subblocks 32, a subblock paired with a free subblock 36, or a subblock paired with a data-erased subblock 36E. Therefore, the selection range 901 of the transcription source block 33 for obtaining a new free subblock 36 includes two paired active subblocks 32, an active subblock 32 paired with a free subblock 36, an active subblock 32 paired with a data-erased subblock 36E, and an active full block 31.

The transcription processing unit 143 selects, for example, an active block 30 having the smallest valid data amount in each subblock as the transcription source block 33 from the active subblocks 32 registered in the active subblock list 55S and the active full blocks 31 registered in the active full block list 55F (that is, from the active subblocks 32 and the active full blocks 31 in the selection range 901). The valid data amount of the active subblock 32 in units of subblocks is the valid data amount of the active subblock 32. The valid data amount of the active full block 31 in units of subblocks is the valid data amount of the active full block 31 converted into units of subblocks. The valid data amount in the active full block 31 converted into units of subblocks is, for example, a value obtained by dividing the valid data amount of the active full block 31 by the number of subblocks (2 in FIG. 17) in the active full block 31.

Alternatively, the transcription processing unit 143 may classify the active subblocks 32 registered in the active subblock list 55S and the active full blocks 31 registered in the active full block list 55F into a plurality of groups according to the valid data amount in units of subblocks. Here, the transcription processing unit 143 selects one active subblock 32 or one active full block 31 as the transcription source block 33 from one or more groups having a smaller valid data amount in units of subblocks among the plurality of groups. In other words, the transcription processing unit 143 may select an active subblock 32 or an active full block 31 having a relatively small valid data amount in units of subblocks as the transcription source block 33. The active subblock 32 or the active full block 31 having the relatively small valid data amount in units of subblocks is, for example, an active subblock 32 or an active full block 31 having a valid data amount in units of subblocks less than an average valid data amount in units of subblocks of all of the active subblocks 32 and the active full blocks 31 by a third value or more.

Then, the transcription processing unit 143 transcribes at least valid data in the selected transcription source block 33 to the transcription destination block 34. The transcription destination block 34 is, for example, a data-erased subblock 36E or a data-erased full block 35E. Thus, the transcription source block 33 becomes a free block, and becomes reusable as a new write destination (or transcription destination) subblock after undergoing the data erase operation. When the transcription source block 33 is an active full block 31, the transcription source block 33 is reusable as two subblocks after undergoing the data erase operation.

### (Free Full Block Allocation Operation)

For example, when the number of free full blocks is smaller than the third threshold value, the transcription processing unit 143 selects either an active full block 31 having a smaller valid data amount or two paired active subblocks 32 having smaller valid data amounts as the transcription source block 33 and obtains a new free full block 35. The two paired active subblocks 32 are also referred to as an active full block in which all subblocks configuring the active full block are active subblocks 32 (that is, do not include any of the free subblocks 36 and the data-erased subblocks 36E). In other words, the transcription processing unit 143 selects a transcription source block 33 based on the valid data amount of each of the plurality of active full blocks 31 and the valid data amount of each of the plurality of active full blocks in which all subblocks configuring the active full block are active subblocks 32. The selection range 902 of the transcription source block 33 for obtaining a new free full block 35 includes, for example, an active full block 31 and two paired active subblocks 32. In the example shown in FIG. 17, the selection range 902 includes active full blocks 920, 921, 922, 923, . . . , and paired active subblocks 910 and 911, 912 and 913, . . . .

Note that the transcription processing unit 143 does not usually select a full block including a data-erased subblock 36E as the transcription source block 33. The reason is that, when a full block including a data-erased subblock 36E is used as the transcription source block 33, the number of free subblocks decreases, and due to the data erase operation on the entire transcription source block 33 that has become a free full block, the degree of wear-out (e.g., the number of erase operations) of the data-erased subblock 36E unnecessarily increases. In FIG. 17, a full block including a data-erased subblock 36E is, for example, a full block including a data-erased subblock 940 and an active subblock 941.

The transcription processing unit 143 does not usually select a full block including a free subblock 36 as the transcription source block 33. The reason is that, when a full block including a free subblock 36 is used as the transcription source block 33, the number of free subblocks decreases. However, immediately after starting to use the memory system 3, for example, a situation may occur in which the number of full blocks used as subblocks increases due to host writes and the number of free subblocks 36 increases as written user data is invalidated. In such a case, the transcription processing unit 143 may select a full block including a free subblock 36 as the transcription source block 33. In FIG. 17, a full block including a free subblock 36 is, for example, a full block including a free subblock 930 and an active subblock 931.

The transcription processing unit 143 selects, for example, an active full block 31 or two paired active subblocks 32 having the smallest valid data amount in units of full blocks as the transcription source block 33 from the active full blocks 31 registered in the active full block list 55F and the paired active subblocks 32 registered in the active subblock list 55S (that is, from the active full blocks 31 or the two paired active subblocks 32 in the selection range 902). Alternatively, the transcription processing unit 143 may classify the active full blocks 31 registered in the active full block list 55F and the two paired active subblocks 32 registered in the active subblock list 55S into a plurality of groups according to the valid data amount in units of full blocks. Here, the transcription processing unit 143 selects one active full block 31 or two paired active subblocks 32 as the transcription source block 33 from one or more groups having a smaller valid data amount among the plurality of groups. In other words, the transcription processing unit 143 may select an active full block 31 having a relatively small valid data amount or two paired active subblocks 32 having a relatively small valid data amount as the transcription source block 33. Note that selecting two paired active subblocks 32 as the transcription source block 33 corresponds to selecting an active full block 31 configured with the two paired active subblocks 32. An active full block 31 having a relatively small valid data amount or two paired active subblocks 32 having a relatively small valid data amount is, for example, an active full block 31 in which the valid data amount in units of full blocks is less by a fourth value or more than an average valid data amount in units of full blocks of all active full blocks 31 and the two paired active subblocks 32, or two paired active subblocks 32 in which the valid data amount in units of full blocks is less by the fourth value or more than the average valid data amount in units of full blocks of all active full blocks 31 and the two paired active subblocks 32.

Then, the transcription processing unit 143 transcribes at least valid data in the selected transcription source block 33 to the transcription destination block 34. The transcription destination block 34 is, for example, a data-erased subblock 36E or a data-erased full block 35E. Thus, the transcription source block 33 becomes a free block, and becomes reusable as a new write destination (or transcription destination) full block after undergoing the data erase operation.

In the free subblock allocation operation and free full block allocation operation described with reference to FIGS. 16 and 17, the transcription processing unit 143 may determine whether valid data of an amount of the full block capacity is stored in a plurality of blocks allocated to a stream corresponding to the transcription source block 33 (hereinafter, also referred to as a plurality of blocks of a target stream). The plurality of blocks of the target stream may include subblocks and full blocks. When valid data of an amount of the full block capacity is stored in the plurality of blocks of the target stream, the transcription processing unit 143 may transcribe the valid data of the amount of the full block capacity from the plurality of blocks of the target stream to the free full block 35. When valid data of an amount less than the full block capacity is stored in the plurality of blocks of the target stream, the transcription processing unit 143 may transcribe valid data of an amount equal to or less than a data capacity of a subblock (subblock capacity) from the plurality of blocks of the target stream to the free subblock 36.

When valid data is transcribed from the transcription source block 33 to the transcription destination block 34, the address conversion information management unit 144, the valid data amount management unit 145, the wear management unit 146, the active block management unit 147, and the free block management unit 148 update information managed by each unit by an operation similar to, for example, the sub-full block transcription operation described above with reference to FIG. 14.

By the above-described second free block allocation operation, the memory system 3 can obtain free subblocks of the number equal to or greater than the second threshold value and free full blocks of the number equal to or greater than the third threshold value when the mode of each full block is not fixed. When the mode of each full block is not fixed, for example, and the sub-full block transcription operation is made to wait until a predetermined timing, in the memory system 3, the number of full blocks used as subblocks is expected to increase immediately after starting to use the memory system 3 due to the host write operation, and after the predetermined timing, the number of full blocks used as a full block is expected to increase relatively due to the sub-full block transcription operation. In other words, when the mode of each full block is not fixed, a ratio of full blocks used as subblocks to full blocks used as a full block in the nonvolatile memory 4 may change.

### (Wear Leveling Operation)

The wear leveling operation is an operation for leveling a wear difference between full blocks and a wear difference between subblocks. The wear leveling operation is performed by, for example, the transcription processing unit 143, the address conversion information management unit 144, the valid data amount management unit 145, the wear management unit 146, the active block management unit 147, and the free block management unit 148.

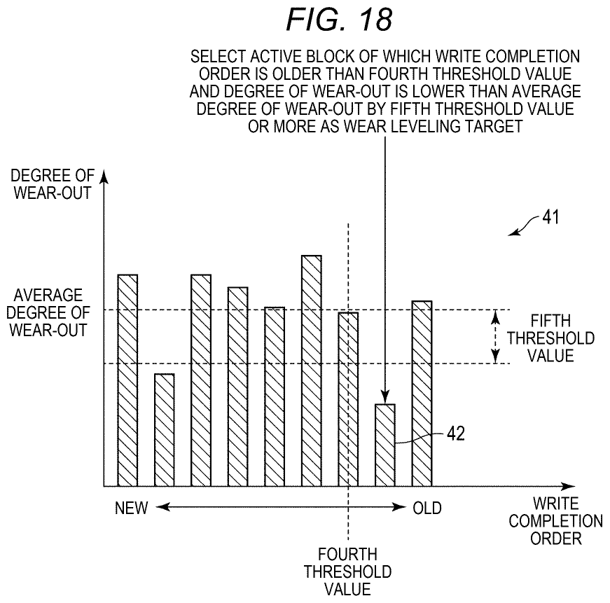

FIG. 18 shows an example of a block to be subjected to the wear leveling operation. In a graph 41 shown in FIG. 18, the horizontal axis indicates a data write completion order regarding the active blocks 30, and the vertical axis indicates a degree of wear-out of the active blocks 30. In the graph 41, a plurality of active blocks 30 are represented by a bar graph based on the data write completion order and the degree of wear-out of each of the active blocks 30.

The block to be subjected to the wear leveling operation is an active block 30 that remains in the active block management information 55 (specifically, the active full block list 55F or the active subblock list 55S) and has a low degree of wear-out. Specifically, for example, an active block 30 of which the write completion order in the active block management information 55 is older than a fourth threshold value and the degree of wear-out is lower than the average degree of wear-out by a fifth threshold value or more is selected as a target of the wear leveling operation. In the example shown in FIG. 18, an active block 42 of which the write completion order is older than the fourth threshold value and the degree of wear-out is lower than the average degree of wear-out by the fifth threshold value or more is selected as the target of the wear leveling operation.

When leveling the wear difference between full blocks, the transcription processing unit 143 selects active full blocks 31 that remain in the active full block list 55F and have a low degree of wear-out as targets of the wear leveling operation. Specifically, the transcription processing unit 143 selects an active full block 31 of which the write completion order is older than the fourth threshold value and the degree of wear-out is lower than the average degree of wear-out by the fifth threshold value or more from the active full block list 55F as the target of the wear leveling operation. The average degree of wear-out is, for example, the average degree of wear-out of all full blocks in the nonvolatile memory 4.

When leveling the wear difference between subblocks, the transcription processing unit 143 selects active subblocks 32 that remain in the active subblock list 55S and have a low degree of wear-out as targets of the wear leveling operation. Specifically, the transcription processing unit 143 selects an active subblock 32 of which the write completion order is older than the fourth threshold value and the degree of wear-out is lower than the average degree of wear-out by the fifth threshold value or more from the active subblock list 55S as the target of the wear leveling operation. The average degree of wear-out is, for example, the average degree of wear-out of all subblocks in the nonvolatile memory 4. More specifically, the average degree of wear-out is, for example, the average degree of wear-out of all full blocks in the nonvolatile memory 4 in units of subblocks. The fourth threshold value and the fifth threshold value used in the wear leveling of the subblocks may be the same as or different from the fourth threshold value and the fifth threshold value used in the wear leveling of the full blocks.

The transcription processing unit 143 sets the active full block 31 or the active subblock 32 selected as the target of the wear leveling operation as the transcription source block 33. The transcription processing unit 143 transcribes at least valid data in the transcription source block 33 to the transcription destination block 34. The transcription destination block 34 is, for example, a data-erased subblock 36E or a data-erased full block 35E. Thus, the transcription source block 33 becomes a free block, and becomes reusable as a new write destination (or transcription destination) full block or subblock after undergoing the data erase operation. When the data erase operation is performed on the transcription source block 33 and the transcription source block 33 is used to store, for example, hot data, the degree of wear-out (the number of erase operations) of the transcription source block 33 is expected to increase. Therefore, the transcription processing unit 143 is expected to level the wear difference between the transcription source block 33 and other blocks. The transcription processing unit 143 selects, for example, a free subblock 36 having a low degree of wear-out or a free full block 35 having a low degree of wear-out as the transcription destination block 34 using the free subblock list 56S and the free full block list 56F. Alternatively, the transcription processing unit 143 may select, for example, a free subblock 36 having a high degree of wear-out or a free full block 35 having a high degree of wear-out as the transcription destination block 34 using the free subblock list 56S and the free full block list 56F. In this case, the degree of wear-out of the transcription destination block 34 is, for example, higher than the degree of wear-out of the transcription source block 33.

When valid data is transcribed from the transcription source block 33 to the transcription destination block 34, the address conversion information management unit 144, the valid data amount management unit 145, the wear management unit 146, the active block management unit 147, and the free block management unit 148 update information managed by each unit by an operation similar to, for example, the sub-full block transcription operation described above with reference to FIG. 14.

By the above-described wear leveling operation, the memory system 3 can level the wear difference between full blocks and the wear difference between subblocks. Here, when the mode of each full block is fixed, wear difference between the full blocks used as subblocks and wear difference between the full blocks used as a full block are respectively leveled, so differences in wear may occur between full block groups used as subblocks and full block groups used as a full block. Meanwhile, when the mode of each full block is not fixed, the mode of each full block may be switched between a usage as a full block and a usage as subblocks by the second free block allocation operation or the like (specifically, the transition of (5) in FIG. 17 or (6) in FIG. 17). As a result, wear is expected to be leveled in the entire nonvolatile memory 4, and a lifetime of the nonvolatile memory 4 can be more effectively utilized. Alternatively, when difference in wear occurs between a full block group used as subblocks and a full block group used as a full block, the mode of each full block may be appropriately switched between the usage as a full block and the usage as subblocks so that the wear difference between the full block group used as subblocks and the full block group used as a full block decreases.

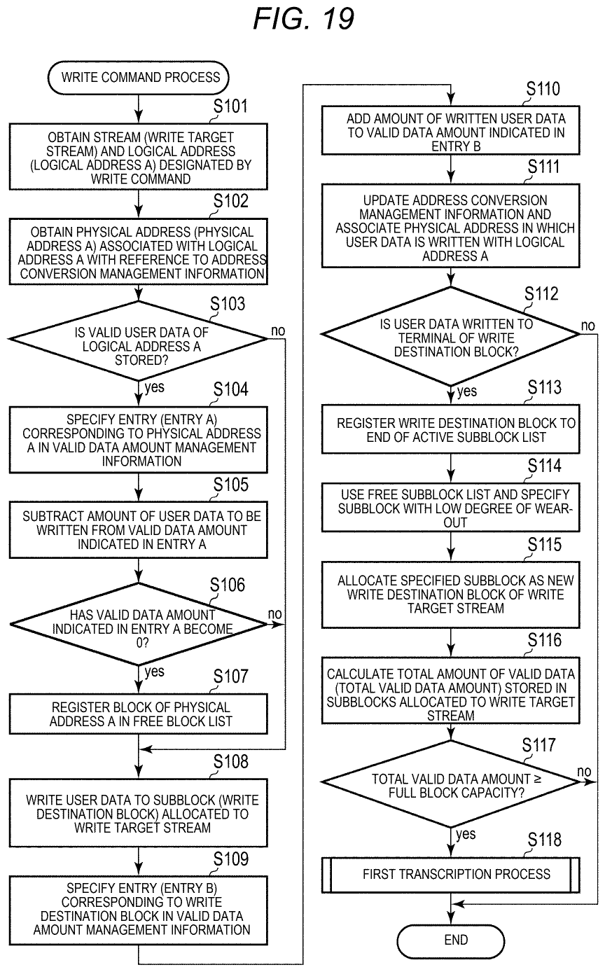

Next, a procedure of a process executed by the CPU 14 of the memory system 3 will be described with reference to FIGS. 19 to 29. Here, an example of a process when the mode of each full block is not fixed will be described as in the example described above with reference to FIG. 17.

### (Write Command Process)

FIG. 19 is a flowchart showing an example of a procedure of a write command process executed by the CPU 14. The write command process is a process of writing user data into a write destination block allocated to a stream designated by a write command, and when valid data of an amount equal to or greater than the full block capacity is stored in a subblock allocated to the stream, transcribing the valid data to a full block. When a write command is received from the host 2, the CPU 14 executes the write command process.

First, the CPU 14 obtains a stream and a logical address designated by the write command (step S101). The stream designated by the write command is referred to as a write target stream. The logical address designated by the write command is referred to as a logical address A. With reference to the address conversion management information 52, the CPU 14 obtains a physical address (hereinafter, referred to as a physical address A) associated with the logical address A (step S102). The physical address A is an address that specifies either one full block or one subblock. The physical address A includes at least a full block ID. When valid user data of the logical address A is stored in the nonvolatile memory 4, the full block ID of the physical address A is set to an ID that can identify the corresponding full block. When valid user data of the logical address A is not stored in the nonvolatile memory 4, the full block ID of the physical address A is set to, for example, “null”.

The CPU 14 determines whether valid user data of the logical address A is stored (step S103). Specifically, the CPU 14 determines whether the full block ID of the physical address A is set to a valid ID or set to “null”.

When valid user data of the logical address A is not stored (no in step S103), that is, when “null” is set as the full block ID of the physical address A, the process by the CPU 14 proceeds to step S108.

When valid user data of the logical address A is stored (yes in step S103), that is, when an ID indicating any full block is set as the full block ID of the physical address A, the CPU 14 specifies an entry corresponding to the physical address A (hereinafter, referred to as an entry A) in the valid data amount management information 53 (step S104). Specifically, the CPU 14 specifies the entry A in the valid data amount management information 53 based on the full block ID and the subblock ID included in the physical address A. The CPU 14 subtracts the amount of user data to be written in response to the write command from the valid data amount indicated in the entry A (step S105). Then, the CPU 14 determines whether the valid data amount indicated in the entry A becomes 0 (step S106). That is, the CPU 14 determines whether the block specified by the physical address A becomes a free block.

When the valid data amount indicated in the entry A is greater than 0 (no in step S106), the process by the CPU 14 proceeds to step S108.

When the valid data amount indicated in the entry A becomes 0 (yes in step S106), the CPU 14 registers the block specified by the physical address A in the free block list (step S107), and proceeds to step S108. Specifically, when the block specified by the physical address A is a full block, the CPU 14 deletes the full block from the active full block list 55F and registers the full block in the free full block list 56F. Meanwhile, when the block specified by the physical address A is a subblock, the CPU 14 deletes the subblock from the active subblock list 55S and registers the subblock in the free subblock list 56S.

Next, the CPU 14 writes the user data into the subblock (write destination block) allocated as the write destination to the write target stream (step S108). The CPU 14 specifies an entry corresponding to the write destination block (hereinafter, referred to as an entry B) in the valid data amount management information 53 (step S109). The CPU 14 adds the amount of written user data to the valid data amount indicated in the entry B (step S110). The CPU 14 updates the address conversion management information 52 and associates the physical address at which the user data is written with the logical address A (step S111). Accordingly, the user data stored at the physical address A is, if any, invalidated.

The CPU 14 determines whether the user data is written to the terminal of the write destination block (step S112). When the user data is not written to the terminal of the write destination block (no in step S112), the CPU 14 ends the write command process.

When the user data is written to the terminal of the write destination block (yes in step S112), the CPU 14 registers the write destination block to the end of the active subblock list 55S (step S113). The CPU 14 uses the free subblock list 56S and specifies a free subblock 36 having a low degree of wear-out (step S114). The CPU 14 allocates the specified free subblock 36 having the low degree of wear-out as a new write destination block for the write target stream (step S115). Note that, for example, the CPU 14 performs the data erase operation on the free subblock 36, and then allocates the data-erased subblock 36E as the write destination block for the write target stream. Here, the CPU 14 adds, for example, 1 to the number of erase operations in the entry of the wear management information 54 corresponding to the subblock. The CPU 14 deletes the allocated free subblock 36 from the free subblock list 56S.

Next, the CPU 14 calculates a total amount of valid data stored in the subblocks allocated to the write target stream (step S116). The total amount of valid data stored in the subblocks allocated to a certain stream is also referred to as a total valid data amount of the stream. Specifically, the CPU 14 uses, for example, the active subblock list 55S and specifies the active subblocks 32 allocated to the write target stream. The CPU 14 obtains the valid data amount of each specified active subblock 32 from the valid data amount management information 53 and calculates a total of the obtained valid data amount as the total valid data amount of the write target stream. The total valid data amount of the write target stream may further include an amount of valid data stored in the current write destination block for the write target stream.

Next, the CPU 14 determines whether the total valid data amount is equal to or greater than the full block capacity (step S117). When the total valid data amount is less than the full block capacity (no in step S117), the CPU 14 ends the write command process.

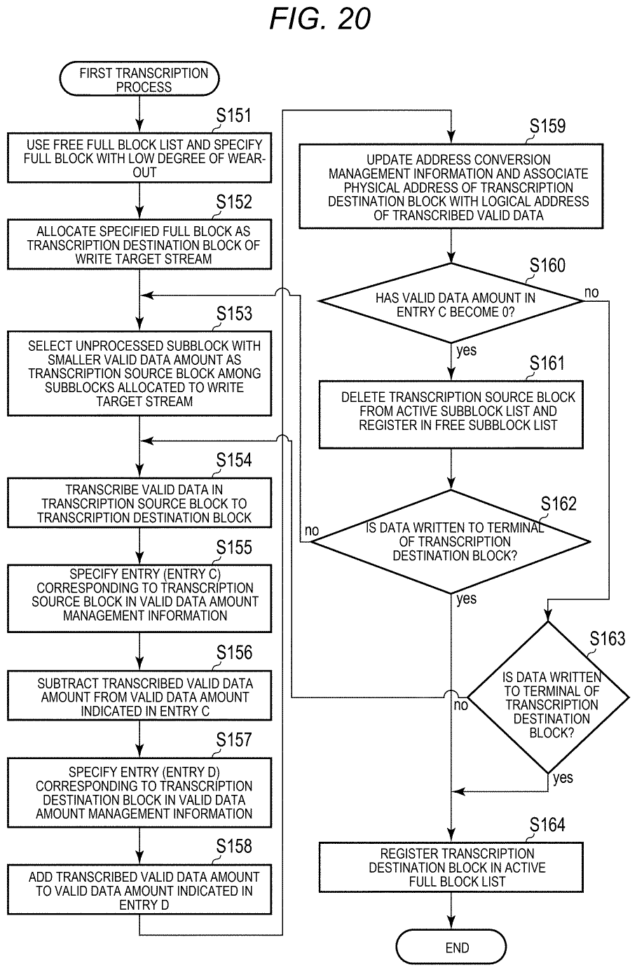

When the total valid data amount is equal to or greater than the full block capacity (yes in step S117), the CPU 14 executes a first transcription process (step S118) and ends the write command process. The first transcription process is a process of transcribing valid data of an amount of the full block capacity stored in a plurality of subblocks allocated to a write target stream to a full block having a low degree of wear-out. The transcription destination full block is, for example, a free full block 35 on which the data erase operation is executed or a data-erased full block 35E. A specific procedure of the first transcription process will be described later with reference to FIG. 20.

By the above-described write command process, the CPU 14 writes user data corresponding to a write command into a write destination subblock allocated to a write destination stream. A subblock is used as the write destination of the user data in response to the write command. Therefore, the CPU 14 can reduce a total storage capacity of the write destination blocks allocated to each of the plurality of streams, thereby preventing decrease in overprovisioning capacity of the memory system 3.

When valid data of an amount equal to or greater than the full block capacity is stored in the plurality of subblocks allocated to the write target stream, the CPU 14 transcribes the valid data of the amount of the full block capacity from the subblocks to a full block. Accordingly, the CPU 14 manages information on a block, which is the transcription destination full block of the valid data, on the full block basis and controls based on the information on the block. This enables easier management than a case where the information is managed in a plurality of subblocks, in which the valid data was stored, on the subblock basis.

### (First Transcription Process)

FIG. 20 is a flowchart showing an example of a procedure of the first transcription process executed by the CPU 14. The first transcription process is a process of transcribing valid data of an amount of the full block capacity stored in subblocks allocated to a write target stream to a full block having a low degree of wear-out. The first transcription process corresponds to step S118 of the write command process described above with reference to FIG. 19.

First, the CPU 14 uses the free full block list 56F and specifies a free full block 35 having a low degree of wear-out (step S151). The CPU 14 allocates the specified free full block 35 having the low degree of wear-out as the transcription destination block 34 for the write target stream (step S152). More specifically, the CPU 14 performs the data erase operation on the specified free full block 35 and allocates the data-erased full block 35E as the transcription destination block 34 for the write target stream. Here, the CPU 14 adds, for example, 1 to the number of erase operations in the entry of the wear management information 54 corresponding to the free full block 35. The CPU 14 deletes the allocated free full block 35 from the free full block list 56F.

The CPU 14 selects an unprocessed subblock having a smaller valid data amount as the transcription source block 33 from the plurality of subblocks allocated to the write target stream (step S153). The CPU 14 transcribes the valid data stored in the transcription source block 33 to the transcription destination block 34 (step S154). That is, the CPU 14 reads the valid data from the transcription source block 33 and writes the read valid data into the transcription destination block 34. The CPU 14 may correct any errors in the read valid data and write the error-corrected valid data into the transcription destination block 34. The CPU 14 specifies an entry corresponding to the transcription source block 33 (hereinafter, referred to as an entry C) in the valid data amount management information 53 (step S155). The CPU 14 subtracts the amount of the transcribed valid data from the valid data amount indicated in the entry C (step S156). The CPU 14 specifies an entry corresponding to the transcription destination block 34 (hereinafter, referred to as an entry D) in the valid data amount management information 53 (step S157). The CPU 14 adds the amount of the transcribed valid data to the valid data amount indicated in the entry D (step S158). The processes of steps S155 and S156 and the processes of steps S157 and S158 may be performed in reverse order or in parallel. Then, the CPU 14 updates the address conversion management information 52 and associates the physical address (physical storage location) of the transcription destination block 34 with the logical address of the transcribed valid data (step S159).

Next, the CPU 14 determines whether the valid data amount indicated in the entry C becomes 0 (step S160). That is, the CPU 14 determines whether the transcription source block 33 becomes a free block.

When the valid data amount indicated in the entry C becomes 0 (yes in step S160), the CPU 14 deletes the transcription source block 33 from the active subblock list 55S and registers the transcription source block 33 in the free subblock list 56S (step S161). When the valid data amount indicated in the entry C is greater than 0 (no in step S160), the process by the CPU 14 proceeds to step S163. Then, the CPU 14 determines whether the data is written to the terminal of the transcription destination block 34 (step S162).

When data is not written to the terminal of the transcription destination block (no in step S162), the process by the CPU 14 returns to step S153. That is, the CPU 14 selects a new transcription source block 33 from the plurality of subblocks allocated to the write target stream and continues the process of transcribing valid data from the new transcription source block 33 to the transcription destination block 34.

When the valid data amount indicated in the entry C is greater than 0 (no in step S160), the CPU 14 determines whether data is written to the terminal of the transcription destination block 34 (step S163).

When data is not written to the terminal of the transcription destination block 34 (no in step S163), the process by the CPU 14 returns to step S154. In other words, when valid data remains in the transcription source block 33 (no in step S160), the CPU 14 continues the process of transcribing the valid data from the same transcription source block 33 (that is, the selected transcription source block 33) to the transcription destination block 34.

When data is written to the terminal of the transcription destination block 34 (yes in step S162 and yes in step S163), the CPU 14 registers the transcription destination block 34 in the active full block list 55F (step S164) and ends the first transcription process. In this way, for the constant transcribed data amount, which is equal to the data amount of the full block capacity of the transcription destination block 34, a subblock having a smaller valid data amount is selected as the transcription source block 33 in step S153. Accordingly, more transcription source blocks 33 can be released as free subblocks 36, thereby preventing increase in the WAF.

By the above-described first transcription process, the CPU 14 can transcribe valid data of an amount of the full block capacity stored in a plurality of subblocks allocated to a write target stream to a free full block 35 having a low degree of wear-out.

### (Read Command Process)

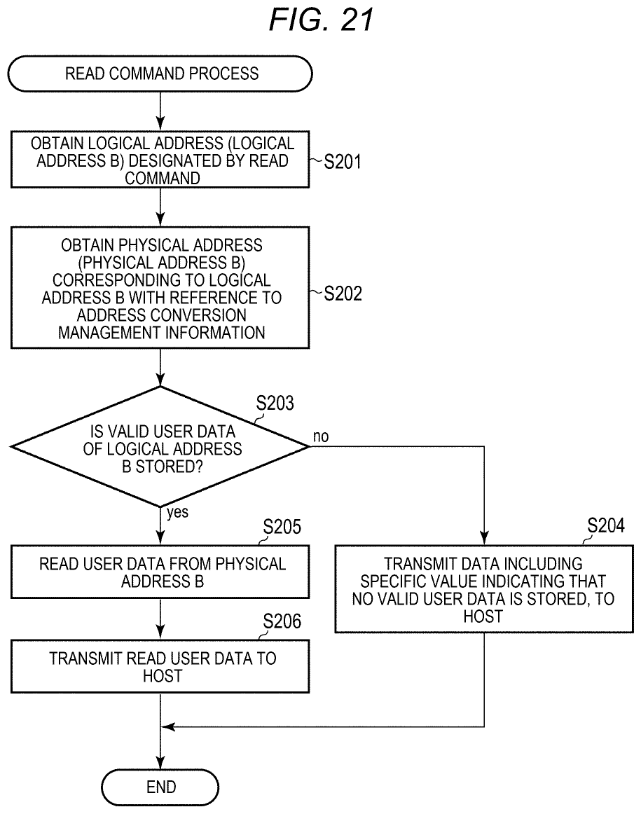

FIG. 21 is a flowchart showing an example of a procedure of a read command process executed by the CPU 14. The read command process is a process of reading user data at a logical address (or a logical address range) designated by a read command, from the nonvolatile memory 4. When the read command is received from the host 2, the CPU 14 executes the read command process.

First, the CPU 14 obtains a logical address (hereinafter, referred to as a logical address B) designated by the read command (step S201). With reference to the address conversion management information 52, the CPU 14 obtains a physical address (hereinafter, referred to as a physical address B) associated with the logical address B (step S202).

The CPU 14 determines whether valid user data at the logical address B is stored in the nonvolatile memory 4 (step S203). Specifically, the CPU 14 determines whether the full block ID of the physical address B is set to an ID that can identify the corresponding full block or set to “null”.

When valid user data at the logical address B is not stored (no in step S203), that is, when “null” is set as the full block ID of the physical address B, the CPU 14 transmits data that includes a certain value indicating that valid user data at the logical address B is not stored, to the host 2 (step S204) and ends the read command process. An example of the data that includes the certain value is bit string data in which all bits are 0.

When valid user data at the logical address B is stored (yes in step S203), that is, when a valid ID indicating any full block is set as the full block ID of the physical address B, the CPU 14 reads user data from the physical address B (step S205). Then, the CPU 14 transmits the read user data to the host 2 (step S206) and ends the read command process. The CPU 14 may correct any errors in the read user data and transmit the error-corrected user data to the host 2.

By the above-described command process, the CPU 14 can read user data from the nonvolatile memory 4 in response to a read command that designates an appropriate logical address and transmit the read user data to the host 2.

### (Free Subblock Allocation Process)

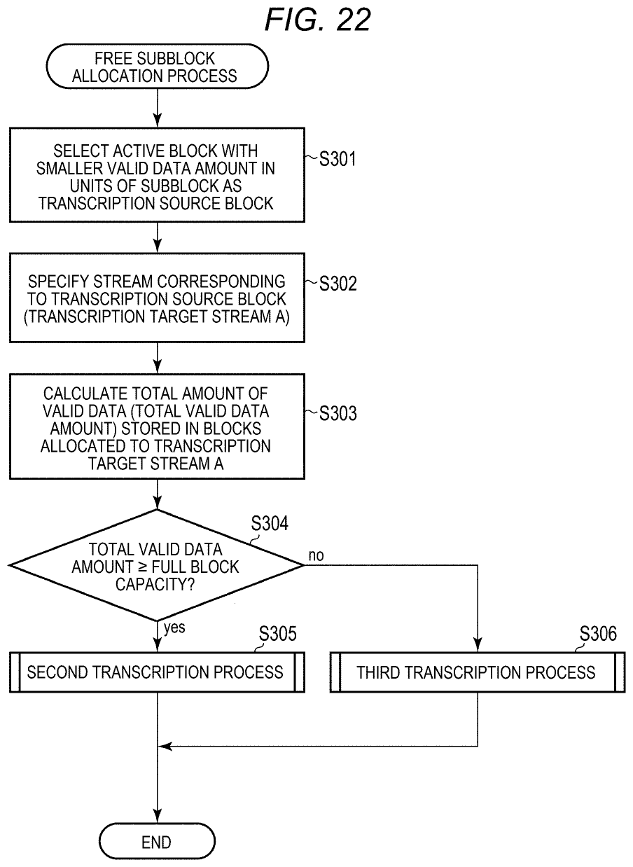

FIG. 22 is a flowchart showing an example of a procedure of a free subblock allocation process executed by the CPU 14. The free subblock allocation process is a process of making the number of free subblocks equal to or greater than the second threshold value. The CPU 14 executes, for example, the free subblock allocation process when the number of free subblocks falls below the second threshold value.

First, the CPU 14 uses the valid data amount management information 53 and selects an active block 30 having a smaller valid data amount in units of subblocks as the transcription source block 33 (step S301). Specifically, the CPU 14 selects an active subblock 32 or an active full block 31 having the smallest valid data amount in units of subblocks as the transcription source block 33, for example, based on (A) a valid data amount of a subblock and (B) a valid data amount of a full block converted into units of subblocks. As described above, a valid data amount of a full block converted into units of subblocks is, for example, a value obtained by dividing a valid data amount of the full block by the number of subblocks in the full block.

The CPU 14 uses the active block management information 55 and specifies a stream (hereinafter, referred to as a transcription target stream A) corresponding to the transcription source block 33 (step S302). The CPU 14 calculates a total amount of valid data (a total valid data amount) stored in blocks allocated to the transcription target stream A (step S303). An example of a method of calculating the total valid data amount of the transcription target stream A will be specifically described. First, the CPU 14 uses the active full block list 55F and specifies an active full block 31 allocated to the transcription target stream A. The CPU 14 uses the active subblock list 55S and specifies active subblocks 32 allocated to the transcription target stream A. The CPU 14 obtains the valid data amount of each specified active full block 31 from the valid data amount management information 53. The CPU 14 obtains the valid data amount of each of the specified active subblocks 32. Then, the CPU 14 calculates a total of the obtained valid data amounts as a total valid data amount of the transcription target stream A. The total valid data amount of the transcription target stream A may further include an amount of valid data stored in the current write destination block for the transcription target stream A.

Next, the CPU 14 determines whether the total valid data amount is equal to or greater than the full block capacity (step S304).

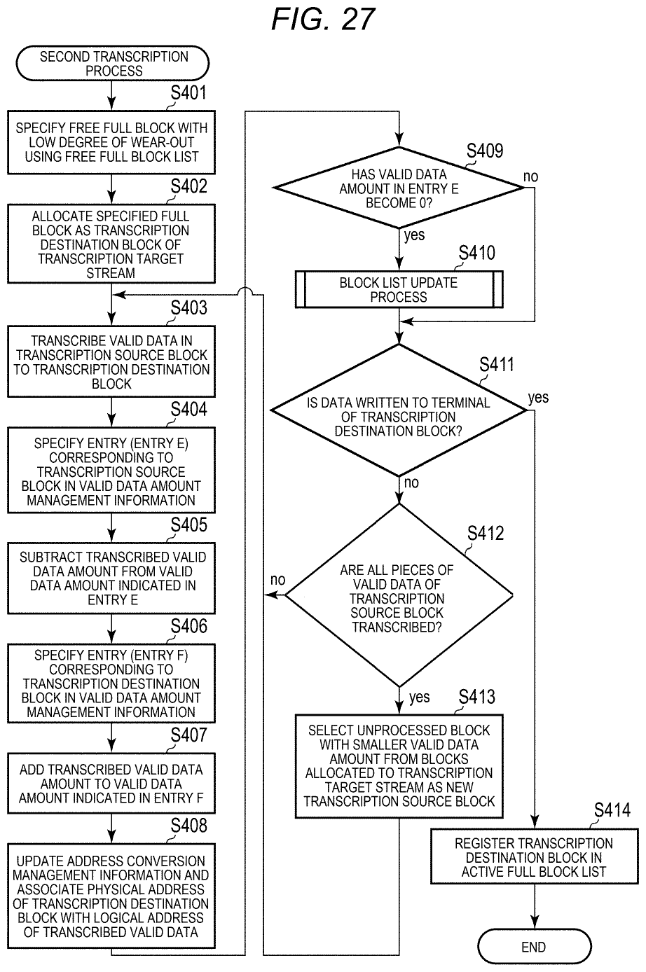

When the total valid data amount is equal to or greater than the full block capacity (yes in step S304), the CPU 14 executes a second transcription process (step S305) and ends the free subblock allocation process. The second transcription process is a process of transcribing valid data of an amount of the full block capacity stored in a block allocated to the transcription target stream (here, the transcription target stream A) to a free full block 35. A specific procedure of the second transcription process will be described later with reference to FIG. 27.

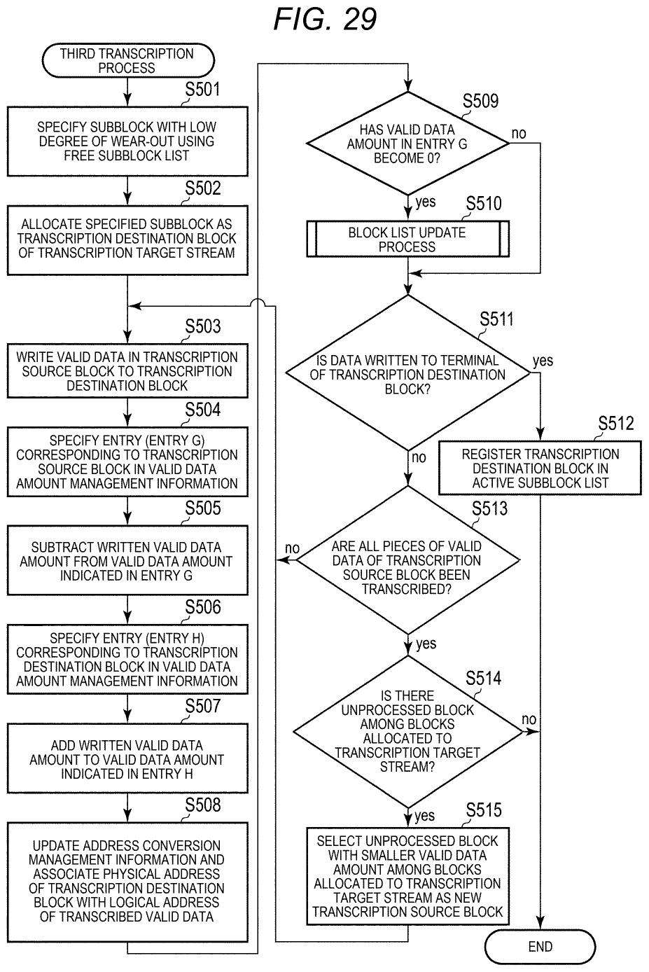

When the total valid data amount is less than the full block capacity (no in step S304), the CPU 14 executes a third transcription process (step S306) and ends the free subblock allocation process. The third transcription process is a process of transcribing valid data of an amount less than the full block capacity stored in a block allocated to the transcription target stream (here, the transcription target stream A) to a free subblock 36. The transcription destination free subblock 36 is, for example, a free subblock 36 on which the data erase operation is executed, or a data-erased subblock 36E. A specific procedure of the third transcription process will be described later with reference to FIG. 29.

By the above-described free subblock allocation process, the CPU 14 selects a transcription source block 33 having a smaller valid data amount, and calculates the total valid data amount stored in blocks allocated to the transcription target stream A corresponding to the transcription source block 33. When the total valid data amount is equal to or greater than the full block capacity, the CPU 14 transcribes valid data of the amount of the full block capacity from the blocks allocated to the transcription target stream A including the transcription source block 33 to the free full block 35. When the total valid data amount is less than the full block capacity, the CPU 14 transcribes valid data of an amount equal to or less than the subblock capacity from the blocks allocated to the transcription target stream A including the transcription source block 33 to the free subblock 36.

The transcription source block 33 becomes a free subblock 36 in response to such transcription of valid data, so that the CPU 14 can obtain free subblocks 36 of the number equal to or greater than the second threshold value. When the number of free subblocks is still below the second threshold value after execution of the free subblock allocation process is completed, the CPU 14 may execute the free subblock allocation process again.

### (Refresh Process)

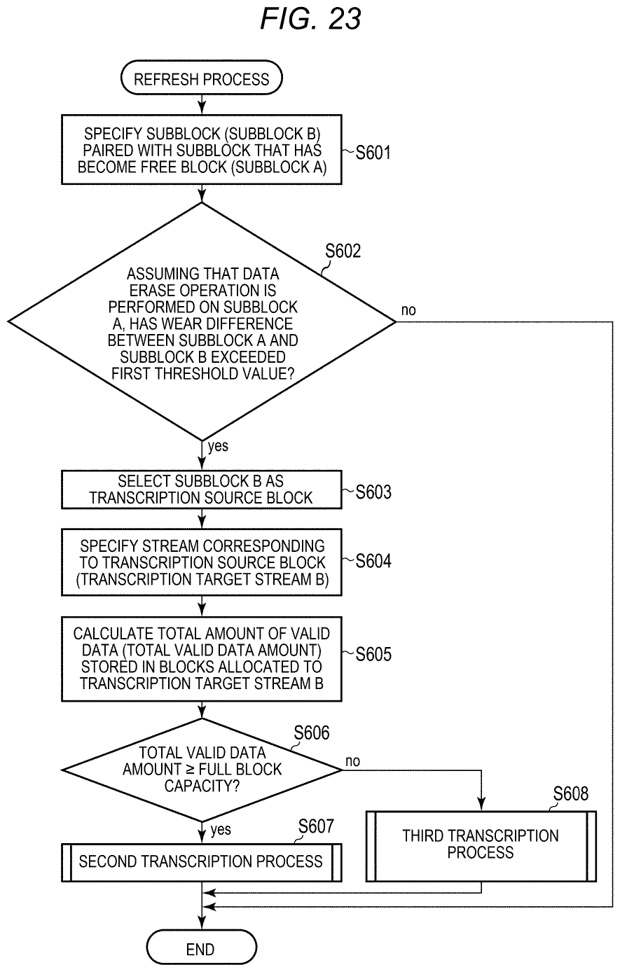

FIG. 23 is a flowchart showing an example of a procedure of a refresh process executed by the CPU 14. The refresh process is a process of recovering reliability of data stored in at least one of a plurality of subblocks configuring one full block. The CPU 14 executes the refresh process, for example, in response to one of subblocks configuring a full block becoming a free block.

First, the CPU 14 specifies a subblock that becomes a free block (hereinafter, referred to as a subblock A) and a subblock (hereinafter, referred to as a subblock B) paired with the subblock A (step S601). Here, it is assumed that the subblock B is an active subblock 32. The CPU 14 determines whether a wear difference between the subblocks A and B exceeds a first threshold value using the wear management information 54, assuming that the data erase operation is performed on the subblock A that becomes a free block (step S602). Specifically, the CPU 14 determines whether a value obtained by subtracting the number of erase operations of the subblock B from a value obtained by adding 1 to the number of erase operations of the subblock A exceeds the first threshold value.

When the wear difference does not exceed the first threshold value (no in step S602), the CPU 14 ends the refresh process.

When the wear difference exceeds the first threshold value (yes in step S602), the CPU 14 selects the subblock B as a transcription source block 33 (step S603). The CPU 14 uses the active subblock list 55S and specifies a stream (hereinafter, referred to as a transcription target stream B) corresponding to the transcription source block 33 (step S604). The CPU 14 uses the active block management information 55 and the valid data amount management information 53 and calculates the total amount of valid data (total valid data amount) stored in the blocks allocated to the transcription target stream B (step S605). Then, the CPU 14 determines whether the total valid data amount is equal to or greater than the full block capacity (step S606).

When the total valid data amount is equal to or greater than the full block capacity (yes in step S606), the CPU 14 performs the second transcription process on the transcription target stream B (step S607) and ends the refresh process. The specific procedure of the second transcription process will be described later with reference to FIG. 27.

When the total valid data amount is less than the full block capacity (no in step S606), the CPU 14 performs the third transcription process on the transcription target stream B (step S608) and ends the refresh process. The specific procedure of the third transcription process will be described later with reference to FIG. 29.

By the above-described refresh process, the CPU 14 can restore reliability of valid data stored in the subblock B paired with the subblock A that becomes a free block. Specifically, assuming that the CPU 14 performs the data erase operation on the subblock A, when the wear difference between the subblock A and the subblock B exceeds the first threshold value, the CPU 14 transcribes at least valid data stored in the subblock B to another block. Accordingly, the CPU 14 can recover reliability of the valid data of the subblock B deteriorated by the USBD.

### (Free Full Block Allocation Process)

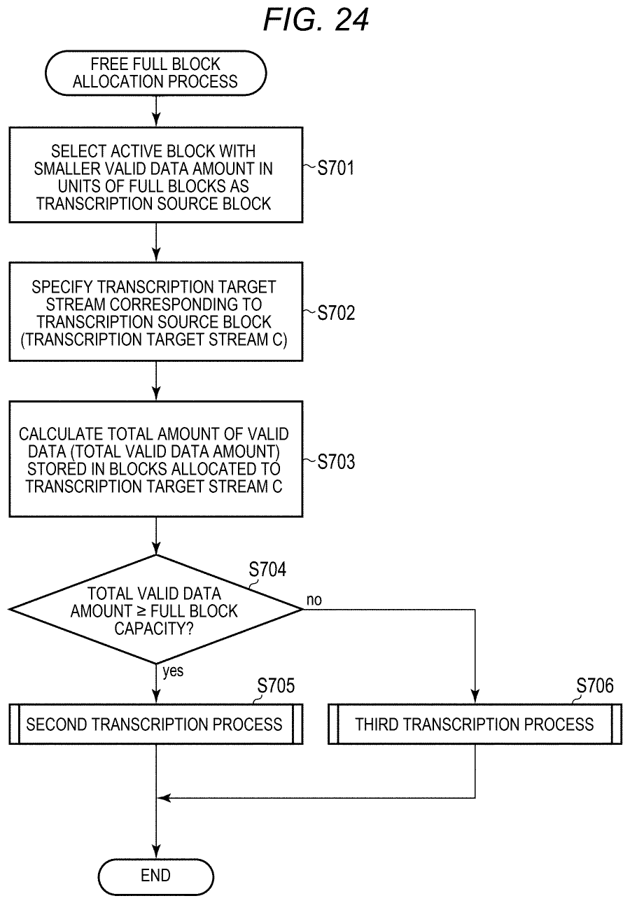

FIG. 24 is a flowchart showing an example of a procedure of a free full block allocation process executed by the CPU 14. The free full block allocation process is a process for making the number of free full blocks equal to or greater than the third threshold value. The CPU 14 executes, for example, the free full block allocation process when the number of free full blocks falls below the third threshold value.

First, the CPU 14 uses the valid data amount management information 53 and selects an active block 30 having a smaller amount of valid data in units of full blocks as the transcription source block 33 (step S701). Specifically, the CPU 14 selects the active block 30 having the smallest valid data amount based on, for example, (A) a valid data amount of a full block and (B) a total of valid data amounts of active subblocks configuring a full block. The selected active block 30 is, for example, either an active full block 31 or a full block including only active subblocks 32.

The CPU 14 uses the active block management information 55 and specifies a stream (hereinafter, referred to as a transcription target stream C) corresponding to the transcription source block 33 (step S702). Here, when the transcription source block 33 is a full block including only active subblocks 32, streams corresponding to the active subblocks 32 may be different. In such a case, the subsequent processes are performed for each of the different streams so that the transcription source block 33 is finally allocated as a free full block. The CPU 14 uses the active block management information 55 and the valid data amount management information 53 and calculates a total amount of valid data (total valid data amount) stored in blocks allocated to the transcription target stream C (step S703). Then, the CPU 14 determines whether the total valid data amount is equal to or greater than the full block capacity (step S704).

When the total valid data amount is equal to or greater than the full block capacity (yes in step S704), the CPU 14 performs the second transcription process on the transcription target stream C (step S705) and ends the free full block allocation process. The specific procedure of the second transcription process will be described later with reference to FIG. 27.

When the total valid data amount is less than the full block capacity (no in step S704), the CPU 14 performs the third transcription process on the transcription target stream C (step S706) and ends the free full block allocation process. The specific procedure of the third transcription process will be described later with reference to FIG. 29.

By the above-described free full block allocation process, the CPU 14 selects a transcription source block 33 having a smaller valid data amount and calculates the total valid data amount stored in the blocks allocated to the transcription target stream C corresponding to the transcription source block 33. When the total valid data amount is equal to or greater than the full block capacity, the CPU 14 transcribes valid data of the amount of the full block capacity from the blocks including the transcription source block 33 allocated to the transcription target stream C to the free full block 35. When the total valid data amount is less than the full block capacity, the CPU 14 transcribes valid data of an amount equal to or less than the subblock capacity from the blocks including the transcription source block 33 allocated to the transcription target stream C to the free subblock 36.

The transcription source block 33 becomes a free full block 35 in response to such transcription of valid data, so that the CPU 14 can allocate free full blocks 35 of a number equal to or greater than the third threshold value. When the number of free full blocks is still below the third threshold value after execution of the free full block allocation process is completed, the CPU 14 may execute the free full block allocation process again.

### (Subblock Wear Leveling Process)

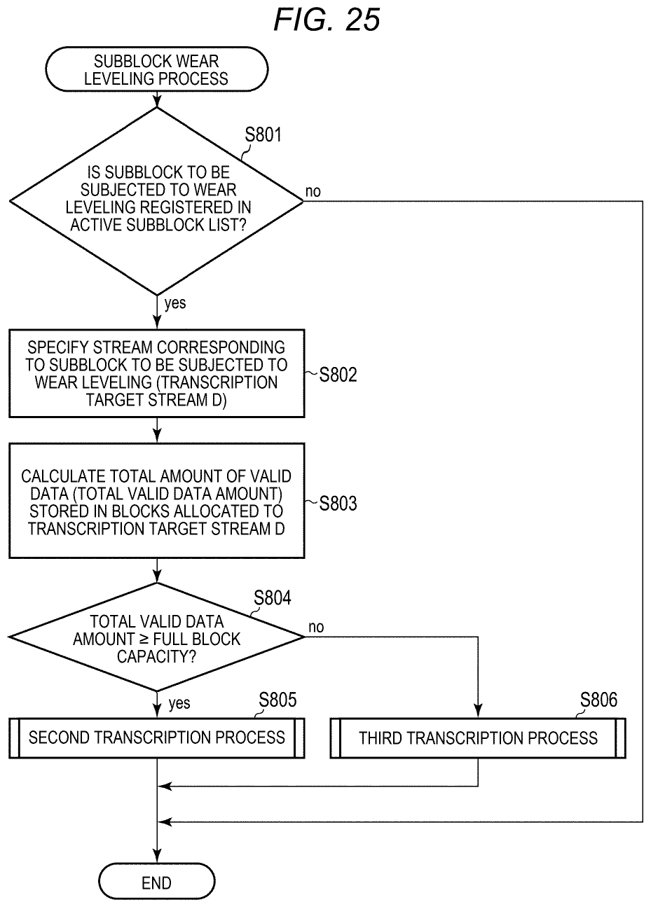

FIG. 25 is a flowchart showing an example of a procedure of a subblock wear leveling process executed by the CPU 14. The subblock wear leveling process is a process of leveling degrees of wear-out of subblocks. The CPU 14 executes the subblock wear leveling process, for example, at regular time intervals.

First, the CPU 14 determines whether a subblock to be subjected to wear leveling is registered in the active subblock list 55S (step S801). Specifically, the CPU 14 uses, for example, the active subblock list 55S and the wear management information 54, and determines whether a subblock of which the data write completion order is older than the fourth threshold value and the degree of wear-out is lower than the average degree of wear-out by the fifth threshold value or more is registered in the active subblock list 55S.

When no subblock to be subjected to wear leveling is registered in the active subblock list 55S (no in step S801), the CPU 14 ends the subblock wear leveling process.

When the subblock to be subjected to wear leveling is registered in the active subblock list 55S (yes in step S801), the CPU 14 specifies a stream (hereinafter, referred to as a transcription target stream D) corresponding to the subblock to be subjected to wear leveling (step S802). The CPU 14 uses the active block management information 55 and the valid data amount management information 53, and calculates a total amount of valid data (total valid data amount) stored in blocks allocated to the specified transcription target stream D (step S803). Then, the CPU 14 determines whether the calculated total valid data amount is equal to or greater than the full block capacity (step S804).

When the total valid data amount is equal to or greater than the full block capacity (yes in step S804), the CPU 14 performs the second transcription process on the transcription target stream D (step S805) and ends the subblock wear leveling process. The specific procedure of the second transcription process will be described later with reference to FIG. 27.

When the total valid data amount is less than the full block capacity (no in step S804), the CPU 14 performs the third transcription process on the transcription target stream D (step S806) and ends the subblock wear leveling process. The specific procedure of the third transcription process will be described later with reference to FIG. 29.

By the above-described subblock wear leveling process, the CPU 14 can level degrees of wear-out of subblocks. Specifically, the CPU 14 transcribes, for example, valid data stored in a subblock at least having an older data write completion order and a degree of wear-out lower than the average degree of wear-out to a block having a high degree of wear-out. Thus, the subblock becomes a free block, and becomes reusable as a new write destination (or transcription destination) subblock after undergoing the data erase operation. By performing the data erase operation, the degree of wear-out (the number of erase operations) of the subblock increases. Therefore, the CPU 14 can reduce a difference in degrees of wear-out between subblocks.

### (Full Block Wear Leveling Process)

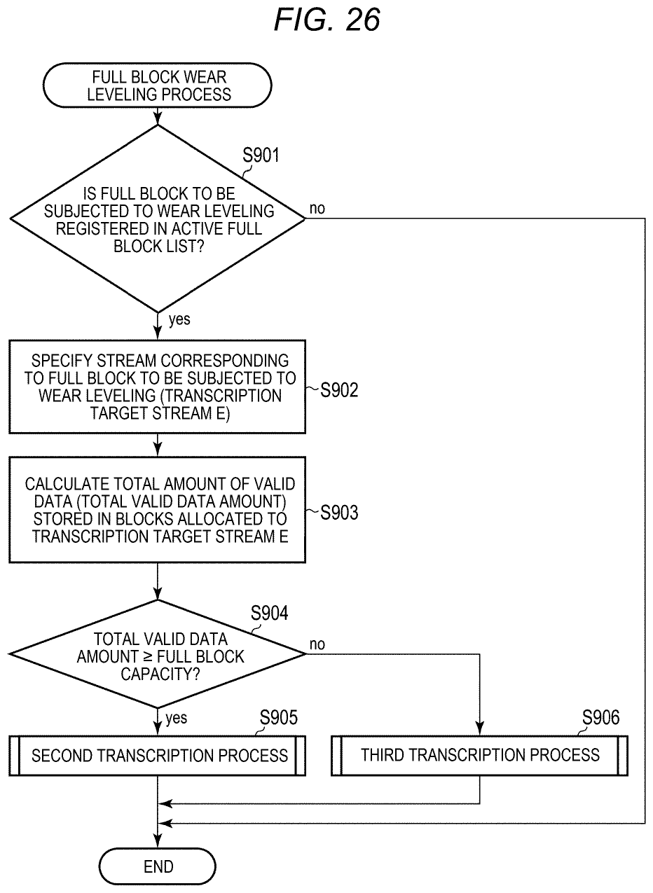

FIG. 26 is a flowchart showing an example of a procedure of a full block wear leveling process executed by the CPU 14. The full block wear leveling process is a process of leveling degrees of wear-out of full blocks. The CPU 14 executes the full-block wear leveling process, for example, at regular time intervals.

First, the CPU 14 determines whether a full block to be subjected to wear leveling is registered in the active full block list 55F (step S901). Specifically, the CPU 14 uses, for example, the active full block list 55F and the wear management information 54, and determines whether a full block of which the data write completion order is older than the fourth threshold value and the degree of wear-out is lower than the average degree of wear-out by the fifth threshold value or more is registered in the active full block list 55F.

When no full block to be subjected to wear leveling is registered in the active full block list 55F (no in step S901), the CPU 14 ends the full-block wear leveling process.

When the full block to be subjected to wear leveling is registered in the active full block list 55F (yes in step S901), the CPU 14 specifies a stream (hereinafter, referred to as a transcription target stream E) corresponding to the full block to be subjected to wear leveling (step S902). The CPU 14 uses the active block management information 55 and the valid data amount management information 53, and calculates a total amount of valid data (total valid data amount) stored in blocks allocated to the specified transcription target stream E (step S903). Then, the CPU 14 determines whether the calculated total valid data amount is equal to or greater than the full block capacity (step S904).

When the total valid data amount is equal to or greater than the full block capacity (yes in step S904), the CPU 14 performs the second transcription process on the transcription target stream E (step S905) and ends the full-block wear leveling process. The specific procedure of the second transcription process will be described later with reference to FIG. 27.

When the total valid data amount is less than the full block capacity (no in step S904), the CPU 14 performs the third transcription process on the transcription target stream E (step S906) and ends the full-block wear leveling process. The specific procedure of the third transcription process will be described later with reference to FIG. 29.

By the above-described full-block wear leveling process, the CPU 14 can level degrees of wear-out of full blocks. Specifically, the CPU 14 transcribes, for example, valid data stored in a full block at least having an older data write completion order and a degree of wear-out lower than the average degree of wear-out to a block having a high degree of wear-out. Thus, the full block becomes a free block, and becomes reusable as a new write destination (or transcription destination) full block after undergoing the data erase operation. By performing the data erase operation, the degree of wear-out (the number of erase operations) of the full block increases. Therefore, the CPU 14 can reduce a difference in degrees of wear-out between full blocks.

### (Second Transcription Process)

FIG. 27 is a flowchart showing an example of a procedure of the second transcription process executed by the CPU 14. The second transcription process is a process of transcribing valid data of an amount of the full block capacity stored in a block allocated to a stream corresponding to a transcription source block 33 (transcription target stream) to a free full block 35. The second transcription process corresponds to, for example, each of steps S305, S607, S705, S805, and S905 of the five processes described above with reference to FIGS. 22 to 26. Here, the transcription target stream in the second transcription process corresponds to each of the transcription target streams A to E in the five processes.

First, the CPU 14 uses the free full block list 56F and specifies a free full block 35 having a low degree of wear-out (step S401). The CPU 14 allocates the specified free full block 35 having the low degree of wear-out as a transcription destination block 34 of the transcription target stream (step S402). Alternatively, the CPU 14 may allocate a free full block 35 having a high degree of wear-out as the transcription destination block 34 of the transcription target stream. The allocated free full block 35 is deleted from the free full block list 56F.

The CPU 14 transcribes valid data stored in the transcription source block 33 to the transcription destination block 34 (step S403). That is, the CPU 14 reads valid data from the transcription source block 33 and writes the read valid data into the transcription destination block 34. The CPU 14 may correct any errors in the read valid data, and write the error-corrected valid data into the transcription destination block 34. The CPU 14 specifies an entry corresponding to the transcription source block 33 (hereinafter, referred to as an entry E) in the valid data amount management information 53 (step S404). The CPU 14 subtracts the amount of the transcribed valid data from the valid data amount indicated in the entry E (step S405). The CPU 14 specifies an entry corresponding to the transcription destination block 34 (hereinafter, referred to as an entry F) in the valid data amount management information 53 (step S406). The CPU 14 adds the amount of the transcribed valid data to the valid data amount indicated in the entry F (step S407). The processes of steps S404 and S405 and the processes of steps S406 and S407 may be performed in reverse order or in parallel. Then, the CPU 14 updates the address conversion management information 52 and associates a physical address of the transcription destination block 34 with a logical address of the transcribed valid data (step S408).

Next, the CPU 14 determines whether the valid data amount indicated in the entry E becomes 0 (step S409). That is, the CPU 14 determines whether the transcription source block 33 becomes a free block.

When the valid data amount indicated in the entry E is greater than 0 (no in step S409), the process by the CPU 14 proceeds to step S411.

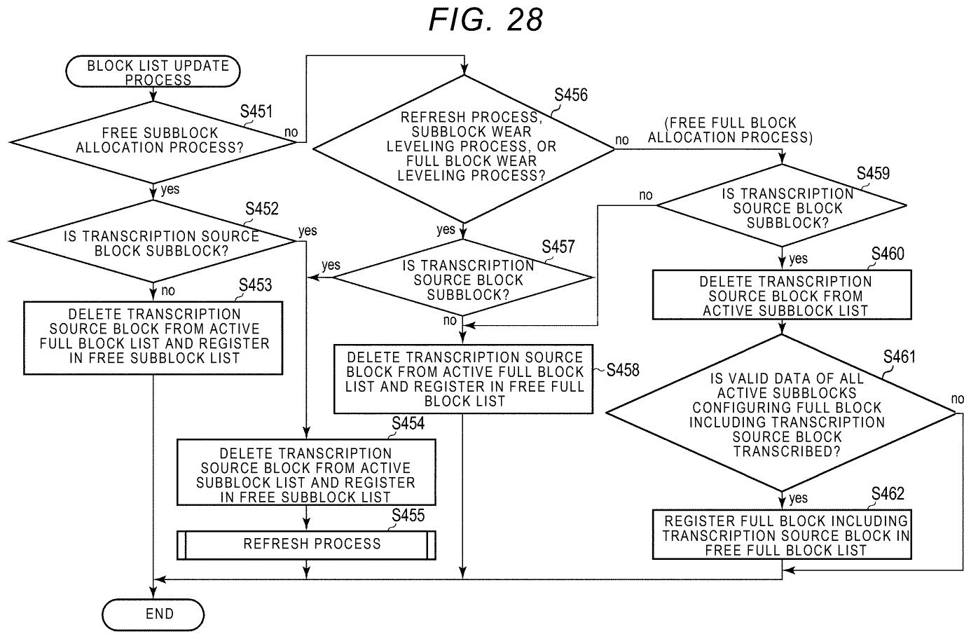

When the valid data amount indicated in the entry E becomes 0 (yes in step S409), the CPU 14 executes a block list update process (step S410). The block list update process is a process of updating the active block management information 55 and the free block management information 56 based on the fact that an active block, that is, the transcription source block 33 becomes a free block. An example of a specific procedure of the block list update process will be described later with reference to FIG. 28.

When the valid data amount indicated in the entry E is greater than 0 (no in step S409), or after the process of step S410, the CPU 14 determines whether data is written to the terminal of the transcription destination block 34 (step S411).

When data is not written to the terminal of the transcription destination block 34 (no in step S411), the process by the CPU 14 proceeds to step S412. In step S412, the CPU 14 determines whether the result of step S409 is yes, that is, whether all pieces of valid data in the transcription source block 33 are transcribed. When not all pieces of valid data in the transcription source block 33 are transcribed (no in step S412), the process by the CPU 14 returns to step S403. When all pieces of valid data in the transcription source block 33 are transcribed (yes in step S412), the CPU 14 selects an unprocessed block having a smaller valid data amount from the blocks allocated to the transcription target stream as the new transcription source block 33 (step S413), and the process by the CPU 14 returns to step S403. The unprocessed block is a block allocated to the transcription target stream and from which valid data is not yet transcribed to the transcription destination block 34. Therefore, a process of transcribing valid data stored in the new transcription source block 33 to the transcription destination block 34 is further performed.

When data is written to the terminal of the transcription destination block 34 (yes in step S411), the CPU 14 registers the transcription destination block 34 in the active full block list 55F (step S414) and ends the second transcription process.

By the above-described second transcription process, the CPU 14 can transcribe valid data of an amount of the full block capacity from a block allocated to a transcription target stream to a free full block 35.

### (Block List Update Process)

FIG. 28 is a flowchart showing an example of a procedure of the block list update process executed by the CPU 14. The block list update process is a process of updating the active full block list 55F or the active subblock list 55S, and the free full block list 56F or the free subblock list 56S based on the fact that an active block, that is, a transcription source block 33, becomes a free block. The block list update process corresponds to, for example, step S410 of the second transcription process described above with reference to FIG. 27. The CPU 14 executes the block list update process when all pieces of valid data in the transcription source block 33 are transcribed to the transcription destination block 34 and thus the transcription source block 33 becomes a free block. A process of transcribing all pieces of valid data in the transcription source block 33 to the transcription destination block 34 is a process proceeded in, for example, any of the free subblock allocation process, the free full block allocation process, the refresh process, the subblock wear leveling process, and the full block wear leveling process.

First, the CPU 14 determines whether a process (target process) in which the transcription source block 33 becomes a free block is the free subblock allocation process (step S451).

When the target process is the free subblock allocation process (yes in step S451), the CPU 14 determines whether the transcription source block 33 is a subblock (step S452).

When the transcription source block 33 is a full block (no in step S452), the CPU 14 deletes the transcription source block 33 from the active full block list 55F and registers the transcription source block 33 in the free subblock list 56S (step S453) and ends the block list update process. In other words, when the transcription source block 33 is a full block, two or more subblocks are released as free subblocks 36 as a result.

When the transcription source block 33 is a subblock (yes in step S452), the CPU 14 deletes the transcription source block 33 from the active subblock list 55S and registers the transcription source block 33 in the free subblock list 56S (step S454). Then, the CPU 14 executes the refresh process (step S455) and ends the block list update process. The refresh process is a process of restoring reliability of data when a wear difference between the transcription source block 33 that is a subblock and a subblock in the same full block as the transcription source block 33 exceeds the first threshold value. An example of a specific procedure of the refresh process is as described above with reference to FIG. 23.

When the target process is not the free subblock allocation process (no in step S451), the CPU 14 determines whether the target process is any one of the refresh process, the subblock wear leveling process, and the full block wear leveling process (step S456).

When the target process is any one of the refresh process, the subblock wear leveling process, and the full block wear leveling process (yes in step S456), the CPU 14 determines whether the transcription source block 33 is a subblock (step S457).

When the transcription source block 33 is a subblock (yes in step S457), the CPU 14 performs the processes of steps S454 and S455 and ends the block list update process. The processes in steps S454 and S455 are as described above.

When the transcription source block 33 is a full block (no in step S457), the CPU 14 deletes the transcription source block 33 from the active full block list 55F and registers the transcription source block 33 in the free full block list 56F (step S458) and then ends the block list update process. That is, the CPU 14 registers the transcription source block 33, which is a full block, in the free full block list 56F, instead of registering as two or more free subblocks in the free subblock list 56S.

When the target process is neither the refresh process, the subblock wear leveling process, nor the full block wear leveling process (no in step S456), that is, when the target process is the free full block allocation process, the CPU 14 determines whether the transcription source block 33 is a subblock (step S459).

When the transcription source block 33 is a full block (no in step S459), the CPU 14 performs the process of step S458 and ends the block list update process. The process of step S458 is as described above.

When the transcription source block 33 is a subblock (yes in step S459), the CPU 14 deletes the transcription source block 33 from the active subblock list 55S (step S460). Then, the CPU 14 determines whether valid data of all active subblocks 32 configuring a full block including the transcription source block 33 is transcribed to the transcription destination block 34 (step S461).

When the valid data of all active subblocks 32 configuring the full block including the transcription source block 33 is transcribed to the transcription destination block 34 (yes in step S461), the CPU 14 registers the full block including the transcription source block 33 in the free full block list 56F (step S462) and ends the block list update process. In other words, the CPU 14 does not register the transcription source block 33, which is a subblock, in the free subblock list 56S, but registers the full block including the finally allocated transcription source block 33 in the free full block list 56F.

When valid data of at least any of the active subblocks 32 configuring the full block including the transcription source block 33 is not yet transcribed to the transcription destination block 34 (no in step S461), the CPU 14 ends the block list update process.

By the above-described block list update process, when an active block that is the transcription source block 33 becomes a free block, the CPU 14 can update the active full block list 55F or the active subblock list 55S, and the free full block list 56F or the free subblock list 56S. Specifically, the CPU 14 deletes the transcription source block 33 that is a subblock from the active subblock list 55S. The CPU 14 deletes the transcription source block 33 that is a full block from the active full block list 55F. The CPU 14 registers the transcription source block 33 (or a full block including the transcription source block 33) in either the free full block list 56F or the free subblock list 56S depending on the process in which the transcription source block 33 becomes a free block.

### (Third Transcription Process)

FIG. 29 is a flowchart showing an example of a procedure of the third transcription process executed by the CPU 14. The third transcription process is a process of transcribing valid data stored in a block allocated to a transcription target stream to a subblock, up to the subblock capacity. The third transcription process corresponds to, for example, steps S306, S608, S706, S806, and S906 of the five processes described above with reference to FIGS. 22 to 26. Here, the transcription target stream in the third transcription process corresponds to each of the transcription target streams A to E in the five processes.

Processes of steps S501 and S502 in the third transcription process correspond to a process in which the free full block 35 and the free full block list 56F, which are described above in steps S401 and S402 in the second transcription process, are each replaced with the free subblock 36 and the free subblock list 56S. The process of steps S503 to S511 in the third transcription process are almost the same as the processes of steps S403 to S411 in the second transcription process described above. Specifically, the processes from steps S503 to S511 correspond to the process in which the entry E in steps S404, S405, and S409 of the second transcription process is replaced with an entry G in steps S504, S505, and S509, and the entry F in steps S406 and S407 is replaced with an entry H in steps S506 and S507. Here, the entry G is an entry corresponding to the transcription source block 33 in the third transcription process. The entry H is an entry corresponding to the transcription destination block 34 in the third transcription process.

When data is written until a terminal of the transcription destination block 34 (yes in step S511), the CPU 14 registers the transcription destination block 34 in the active subblock list 55S (step S512) and ends the third transcription process.

When data is not written to the terminal of the transcription destination block 34 (no in step S511), the process by the CPU 14 proceeds to step S513. In step S513, the CPU 14 determines whether the result of step S509 is yes, that is, whether all pieces of valid data in the transcription source block 33 are transcribed. When not all pieces of valid data in the transcription source block 33 are transcribed (no in step S513), the process by the CPU 14 returns to step S503. When all pieces of valid data in the transcription source block 33 are transcribed (yes in step S513), the CPU 14 determines whether an unprocessed block exists among the blocks allocated to the transcription target stream (step S514). When an unprocessed block exists (yes in step S514), the CPU 14 selects an unprocessed block having a smaller valid data amount from the blocks allocated to the transcription target stream as the new transcription source block 33 (step S515), and the process by the CPU 14 returns to step S503. In other words, a process of transcribing valid data stored in the new transcription source block 33 to the transcription destination block 34 is further performed.

When an unprocessed block does not exist (no in step S514), the CPU 14 ends the third transcription process. Since data is not written to the terminal of the transcription destination block 34, the transcription destination block 34 may be used for writing user data when a write command is received from the host 2 or for a subsequent process in which the subblock becomes the transcription destination block 34 (for example, the next third transcription process). When valid data of a stream of an amount less than the subblock capacity is stored in a plurality of blocks, the transcription destination of the third transcription process may not be a free subblock 36, but remaining memory areas of a subblock associated with the stream undergoing the host write process (for example, the subblocks 611, 612, 621, 622 in FIG. 14).

By the above-described third transcription process, the CPU 14 can transcribe valid data of an amount equal to or less than the subblock capacity from a block allocated to a transcription target stream to a free subblock 36.

As described above, according to the embodiment, the nonvolatile memory 4 can be more efficiently used.

The nonvolatile memory 4 includes a plurality of full blocks, each of which can be divided into two or more subblocks and has a full block capacity. The free block management unit 148 sets each of the plurality of full blocks to either the full block mode or the subblock mode such that the plurality of full blocks include a plurality of first full blocks set to the full block mode and a plurality of second full blocks set to the subblock mode. The full block set to the full block mode is used as a full block. The full block set to the subblock mode is used as two or more subblocks. The two or more subblocks included in the full block set to the subblock mode include a plurality of first subblocks. The write command processing unit 141 manages a plurality of management units (for example, a plurality of streams 60). The plurality of management units include at least a first management unit (for example, the zeroth stream 600). The write command processing unit 141 allocates a plurality of second subblocks (for example, the write destination blocks or the active subblocks) among the plurality of first subblocks to the first management unit. In response to receiving, from the host 2, a write request of first data associated with the first management unit, the write command processing unit 141 writes the first data into a third subblock (for example, the write destination block) among the plurality of second subblocks allocated to the first management unit. When a total data amount of valid data stored in a plurality of fourth subblocks (for example, the active subblocks) among the plurality of second subblocks reaches the first capacity, the transcription processing unit 143 transcribes valid data of an amount of the first capacity from the plurality of fourth subblocks to one of the plurality of first full blocks.

As such, in the memory system 3, the plurality of second subblocks are allocated to each of the plurality of management units by the host 2. Thus, for example, compared to when allocating a plurality of full blocks to each of a plurality of management units, in the memory system 3, the total storage capacity of the blocks allocated as write destinations to each of a plurality of management units decreases. Therefore, in the memory system 3, decrease in overprovisioning capacity can be prevented.

In the memory system 3, valid data of an amount of the first capacity is transcribed from the plurality of fourth subblocks to the third full block. Thus, information on the third full block to which valid data is transcribed is managed, so that management of information on the block and control based on the information on the blocks become easier than management of information on the plurality of fourth subblocks in which the valid data was stored. Therefore, in the memory system 3, it is possible to easily manage the blocks in the nonvolatile memory 4.

Therefore, in the memory system 3, the nonvolatile memory 4 can be used efficiently.

Each of the various functions described in the embodiment may be implemented by a circuit (processing circuit). Examples of the processing circuit include a programmed processor such as a central processing unit (CPU). The processor implements each of the described functions by executing a computer program (set of instructions) stored in a memory. The processor may be a microprocessor that includes an electrical circuit. Examples of the processing circuit include a digital signal processor (DSP), an application specific integrated circuit (ASIC), a microcontroller, a controller, and other electrical circuit components. Each of components other than the CPU described in the embodiment may also be implemented by a processing circuit.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system connectable to a host, the memory system comprising:
a nonvolatile memory including a plurality of full blocks, each of which is divisible into two or more subblocks and has a first capacity; and
a controller electrically connected to the nonvolatile memory and configured to:
set each of the plurality of full blocks to either a first mode or a second mode such that the plurality of full blocks include a plurality of first full blocks set to the first mode and a plurality of second full blocks set to the second mode, the full block set to the first mode being used as a full block, the full block set to the second mode being used as two or more subblocks, the two or more subblocks included in the full block set to the second mode including a plurality of first subblocks;
manage a plurality of management units, the plurality of management units including at least a first management unit;
allocate a plurality of second subblocks among the plurality of first subblocks to the first management unit;
in response to receiving, from the host, a write request of first data associated with the first management unit, write the first data into a third subblock among the plurality of second subblocks allocated to the first management unit; and
when a total data amount of valid data stored in a plurality of fourth subblocks among the plurality of second subblocks reaches the first capacity, transcribe valid data of an amount of the first capacity from the plurality of fourth subblocks to one of the plurality of first full blocks.

2. The memory system according to claim 1, wherein
the plurality of first subblocks include a fifth subblock and a sixth subblock and a free subblock in which valid data is not stored, the fifth subblock and the sixth subblock are included in the same one of the plurality of second full blocks, and
the controller is further configured to:
when a difference obtained by subtracting a second degree of wear-out of the sixth subblock from a first degree of wear-out of the fifth subblock exceeds a first threshold value, transcribe valid data stored in the sixth subblock to the free subblock.

3. The memory system according to claim 2, wherein
the first degree of wear-out is based on the number of times a data erase operation is performed on the fifth subblock, and
the second degree of wear-out is based on the number of times a data erase operation is performed on the sixth subblock.

4. The memory system according to claim 1, wherein
the plurality of first subblocks include a plurality of active subblocks each storing valid data and a plurality of free subblocks each not storing valid data,
the plurality of first full blocks include a plurality of active full blocks each storing valid data and a plurality of free full blocks each not storing valid data, and
the controller is further configured to:
when the number of the plurality of free subblocks is smaller than a second threshold value,
select a first active block from the plurality of active subblocks and the plurality of active full blocks based on an amount of valid data stored in each of the plurality of active subblocks and an amount of valid data in units of subblocks stored in each of the plurality of active full blocks; and
transcribe at least valid data stored in the first active block to a first free subblock among the plurality of free subblocks or a first free full block among the plurality of free full blocks.

5. The memory system according to claim 4, wherein
the plurality of management unit further includes a second management unit, and
the controller is further configured to:
determine that the first active block is associated with the second management unit;
specify one or more second active blocks associated with the second management unit among the plurality of active subblocks and the plurality of active full blocks, the one or more second active blocks including at least the first active block;
when a total amount of valid data stored in the one or more second active blocks is equal to or greater than the first capacity, transcribe valid data of an amount of the first capacity from the one or more second active blocks to the first free full block; and
when the total amount is less than the first capacity, transcribe valid data of an amount equal to or less than a second capacity from the one or more second active blocks to the first free subblock, the second capacity being a capacity of each of the plurality of first subblocks.

6. The memory system according to claim 4, wherein
the controller is configured to, when the number of the plurality of free subblocks is smaller than the second threshold value, select the active subblock or the active full block storing a smallest amount or a relatively small amount of valid data in units of subblocks as the first active block among the plurality of active subblocks and the plurality of active full blocks.

7. The memory system according to claim 1, wherein
the plurality of first full blocks include a plurality of first active full blocks each storing valid data and a plurality of free full blocks each not storing valid data,
the plurality of second full blocks include a plurality of second active full blocks each storing valid data in all of the two or more subblocks configuring each second active full block,
the plurality of first subblocks include a plurality of free subblocks each not storing valid data, and
the controller is further configured to:
when the number of the plurality of free full blocks is smaller than a third threshold value;
select a third active full block from the plurality of first active full blocks and the plurality of second active full blocks based on an amount of valid data stored in each of the plurality of first active full blocks and an amount of valid data stored in each of the plurality of second active full blocks; and
transcribe at least valid data stored in the third active full block to a first free subblock among the plurality of free subblocks or a first free full block among the plurality of free full blocks.

8. The memory system according to claim 7, wherein
the plurality of management unit further includes a third management unit,
the plurality of second full blocks further include a plurality of fourth active full blocks, each of the plurality of fourth active full blocks including, as the two or more subblocks, at least one of the plurality of free subblocks and at least one subblock storing valid data, and
the controller is further configured to:
determine that the third active full block is associated with the third management unit;
specify one or more fifth active full blocks associated with the third management unit among the plurality of first active full blocks, the plurality of second active full blocks, and the plurality of fourth active full blocks, the one or more fifth active full blocks including at least the third active full block;
when a total amount of valid data stored in the one or more fifth active full blocks is equal to or greater than the first capacity, transcribe valid data of an amount of the first capacity from the one or more fifth active full blocks to the first free full block; and
when the total amount is less than the first capacity, transcribe valid data of an amount equal to or less than a second capacity from the one or more fifth active full blocks to the first free subblock, the second capacity being a capacity of each of the plurality of first subblocks.

9. The memory system according to claim 7, wherein the controller is configured to, when the number of the plurality of free full blocks is smaller than the third threshold value, select the first active full block or the second active full block storing a smallest amount or a relatively small amount of valid data as the third active full block among the plurality of first active full blocks and the plurality of second active full blocks.

10. The memory system according to claim 1, wherein
the plurality of first subblocks include a plurality of active subblocks each storing valid data and a plurality of free subblocks each not storing valid data,
the plurality of first full blocks include a plurality of free full blocks each not storing valid data, and
the controller is further configured to:
when the number of the plurality of free subblocks is smaller than a second threshold value,
select a first active subblock from the plurality of active subblocks based on an amount of valid data stored in each of the plurality of active subblocks; and
transcribe at least valid data stored in the first active subblock to a first free subblock among the plurality of free subblocks or a first free full block among the plurality of free full blocks.

11. The memory system according to claim 10, wherein
the plurality of management unit further includes a fourth management unit, and
the plurality of first full blocks further include a plurality of active full blocks each storing valid data, and
the controller is further configured to:
determine that the first active subblock is associated with the fourth management unit;
specify one or more second active blocks associated with the fourth management unit among the plurality of active subblocks and the plurality of active full blocks, the one or more second active blocks including at least the first active subblock;
when a total amount of valid data stored in the one or more second active blocks is equal to or greater than the first capacity, transcribe valid data of an amount of the first capacity from the one or more second active blocks to the first free full block; and
when the total amount is less than the first capacity, transcribe valid data of an amount equal to or less than a second capacity from the one or more second active blocks to the first free subblock, the second capacity being a capacity of each of the plurality of first subblocks.

12. The memory system according to claim 10, wherein
the controller is configured to, when the number of the plurality of free subblocks is smaller than the second threshold value, select an active subblock storing a smallest amount or a relatively small amount of valid data as the first active subblock among the plurality of active subblocks.

13. The memory system according to claim 1, wherein
the plurality of first subblocks include a plurality of active subblocks each storing valid data and a plurality of free subblocks each not storing valid data,
the plurality of first full blocks include a plurality of active full blocks each storing valid data and a plurality of free full blocks each not storing valid data, and
the controller is further configured to:
when the number of the plurality of free full blocks is smaller than a third threshold value;
select a sixth active full block from the plurality of active full blocks based on an amount of valid data stored in each of the plurality of active full blocks; and
transcribe at least valid data stored in the sixth active full block to a first free subblock among the plurality of free subblocks or a first free full block among the plurality of free full blocks.

14. The memory system according to claim 13, wherein
the plurality of management unit further includes a fifth management unit, and
the controller is further configured to:
determine that the sixth active full block is associated with the fifth management unit;
specify one or more second active blocks associated with the fifth management unit among the plurality of active full blocks and the plurality of active subblocks, the one or more second active blocks including at least the sixth active full block;
when a total amount of valid data stored in the one or more second active blocks is equal to or greater than the first capacity, transcribe valid data of an amount of the first capacity from the one or more second active blocks to the first free full block; and
when the total amount is less than the first capacity, transcribe valid data of an amount equal to or less than a second capacity from the one or more second active blocks to the first free subblock, the second capacity being a capacity of each of the plurality of first subblocks.

15. The memory system according to claim 13, wherein
the controller is configured to, when the number of the plurality of free full blocks is smaller than the third threshold value, select an active full block storing a smallest amount or a relatively small amount of valid data as the sixth active full block among the plurality of active full blocks.

16. The memory system according to claim 1, wherein
the plurality of first subblocks include a plurality of active subblocks each storing valid data and a plurality of free subblocks each not storing valid data,
the plurality of first full blocks include a plurality of active full blocks each storing valid data and a plurality of free full blocks each not storing valid data, and
the controller is further configured to, when one of the plurality of active subblocks satisfies a condition that (A) a write completion order of the one of the plurality of active subblocks is older than a fourth threshold value and (B) a degree of wear-out of the one of the plurality of active subblocks is lower than an average degree of wear-out of the plurality of full blocks in units of subblocks by a fifth threshold value or more, transcribe at least valid data stored in the one of the plurality of active subblocks to any of the plurality of free subblocks or any of the plurality of free full blocks.

17. The memory system according to claim 1, wherein
the plurality of first subblocks include a plurality of active subblocks each storing valid data and a plurality of free subblocks each not storing valid data,
the plurality of first full blocks include a plurality of active full blocks each storing valid data and a plurality of free full blocks each not storing valid data, and
the controller is further configured to, when one of the plurality of active full blocks satisfies a condition that (A) a write completion order of the one of the plurality of active full blocks is older than a fourth threshold value and (B) a degree of wear-out of the one of the plurality of active full blocks is lower than an average degree of wear-out of the plurality of full blocks by a fifth threshold value or more, transcribe at least valid data stored in the one of the plurality of active full blocks to any of the plurality of free subblocks or any of the plurality of free full blocks.

18. The memory system according to claim 1, wherein
the plurality of full blocks are a plurality of physical blocks.

19. The memory system according to claim 1, wherein
the nonvolatile memory includes a plurality of memory chips each including a plurality of physical blocks, and
each of the plurality of full blocks is a set of one or more physical blocks selected from each of the plurality of memory chips.

20. The memory system according to claim 18, wherein
the plurality of management units are a plurality of streams.
